(19) United States
(12) Patent Application Publication
(10) Pub. No.: US 2020/0004386 A1
(43) Pub. Date: Jan. 2, 2020

(54) USER INTERFACE DISPLAY METHOD, APPARATUS, AND USER INTERFACE

(71) Applicant: HUAWEI TECHNOLOGIES CO., LTD., Shenzhen (CN)

(72) Inventor: Junxiong SUN, Shanghai (CN)

(21) Appl. No.: 16/465,206

(22) PCT Filed: Mar. 27, 2017
(86) PCT No.: PCT/CN2017/078336

§ 371 Date: May 30, 2019

(30) Foreign Application Priority Data
Nov. 30, 2016 (CN) 201611082251.4

(51) Int. Cl. G06F 3/0481; H04M 1/725; G06F 9/451; G06F 3/041

(52) U.S. Cl. CPC G06F 3/0481; H04M 1/72597; G06F 3/0412; G06F 3/0416; G06F 9/451

(57) ABSTRACT

This application relates to the field of terminal technologies and provides a user interface display method, an apparatus, and a user interface, so as to diversify an effect of a UI displayed by a mobile terminal. The method includes: displaying, by a mobile terminal, a first UI; obtaining, by the mobile terminal, a first instruction entered by a user in the first UI; and displaying, by the mobile terminal in response to the first instruction, a second UI in the first UI by using a first graphic, where the first graphic is predefined, and the second UI is a UI to be displayed after the mobile terminal performs a first operation.

This application claims priority to Chinese Patent Application No. 201611082251.4, filed with the Chinese Patent Office on Nov. 30, 2016 and entitled “MOBILE TERMINAL INTERFACE DISPLAY METHOD AND DEVICE”, which is incorporated herein by reference in its entirety.

### TECHNICAL FIELD

This application relates to the field of terminal technologies, and in particular, to a user interface (user interface, UI) display method, an apparatus, and a user interface.

### BACKGROUND

With continuous development of mobile technologies, mobile terminals with an operating system are more widely applied. Common operating systems include an Android (Android) operating system and an iOS operating system. The Android operating system is used as an example. In a mobile terminal with the Android operating system, a UI displayed by the mobile terminal is usually drawn on a per-window (window surface) basis at a bottom layer (for example, an activity layer) of the Android operating system.

Specifically, the mobile terminal may draw a window on a per-triangle basis at the bottom layer of the Android operating system, and fill to-be-displayed content in the window, to form the UI. For example, as shown in FIG. 1, the mobile terminal may draw two right triangles (for example, a right triangle A and a right triangle B in FIG. 1) to draw a rectangular window, and fill to-be-displayed content in the rectangular window, to form a rectangular UI. In other words, the UI displayed by the mobile terminal is usually a fixed rectangular UI.

However, because the UI displayed by the mobile terminal is usually a fixed rectangular UI, an effect of the UI displayed by the mobile terminal is not diversified enough.

### SUMMARY

This application provides a user interface display method, an apparatus, and a user interface, so as to diversify an effect of a UI displayed by a mobile terminal.

To achieve the foregoing objective, this application uses the following technical solutions.

According to a first aspect, a user interface display method is provided. When a mobile terminal displays a first UI, the mobile terminal obtains a first instruction that is entered by a user in the first UI and that is used to trigger the mobile terminal to perform a first operation, and displays, in response to the first instruction, a second UI (the second UI is a UI to be displayed after the mobile terminal performs the first operation) in the first UI by using a first graphic (the first graphic is predefined).

According to the user interface display method provided in this application, when the mobile terminal displays the first UI, the mobile terminal may display, in response to the first instruction entered by the user in the first UI, the second UI in the first UI by using the predefined first graphic. Therefore, in this application, the second UI displayed by the mobile terminal is not limited to a fixed rectangle. In this way, an effect of a UI displayed by the mobile terminal can be diversified.

In a first optional implementation of the first aspect, a method for displaying the second UI in the first UI by the mobile terminal by using the first graphic may include: dynamically displaying, by the mobile terminal, the second UI in the first UI by using the first graphic. In this way, because the mobile terminal may dynamically display the second UI, an effect of a UI displayed by the mobile terminal can be further diversified.

In a second optional implementation of the first aspect, the user interface display method provided in this application may further include: obtaining, by the mobile terminal, a second instruction that is entered by the user and that is used to trigger the mobile terminal to select the first graphic.

In a third optional implementation of the first aspect, before the mobile terminal displays the second UI by using the first graphic, the user interface display method provided in this application may further include: obtaining, by the mobile terminal, a location parameter of the first graphic and a location parameter of the second UI. Specifically, a method for obtaining the location parameter of the first graphic and the location parameter of the second UI by the mobile terminal includes: obtaining, by the mobile terminal, the location parameter of the first graphic; and obtaining the location parameter of the second UI based on the location parameter of the first graphic. In this way, the mobile terminal can first obtain the location parameter of the first graphic, and then obtain the location parameter of the second UI based on the location parameter of the first graphic.

In a fourth optional implementation of the first aspect, the location parameter of the first graphic includes coordinates of a central point of the first graphic and coordinates of vertices of the first graphic. A method for obtaining the location parameter of the first graphic by the mobile terminal includes: obtaining, by the mobile terminal, the coordinates of the central point of the first graphic, a radius of the first graphic, and a quantity of vertices of the first graphic; and obtaining the coordinates of the vertices of the first graphic based on the coordinates of the central point of the first graphic, the radius of the first graphic, and the quantity of vertices of the first graphic. In this way, the mobile terminal can obtain the coordinates of the central point of the first graphic and the coordinates of the vertices of the first graphic.

In a fifth optional implementation of the first aspect, the coordinates of the central point of the first graphic include a horizontal coordinate of the central point of the first graphic and a vertical coordinate of the central point of the first graphic, and the coordinates of the vertices of the first graphic include horizontal coordinates of the vertices of the first graphic and vertical coordinates of the vertices of the first graphic. A method for obtaining the coordinates of the vertices of the first graphic by the mobile terminal based on the coordinates of the central point of the first graphic, the radius of the first graphic, and the quantity of vertices of the first graphic includes: obtaining, by the mobile terminal, the horizontal coordinates of the vertices of the first graphic based on the horizontal coordinate of the central point of the first graphic, the radius of the first graphic, and the quantity of vertices of the first graphic by using a first formula; and obtaining the vertical coordinates of the vertices of the first graphic based on the vertical coordinate of the central point of the first graphic, the radius of the first graphic, and the quantity of vertices of the first graphic by using a second formula. The first formula is P_{Xi}=P_{X0}+R*cos(i*360/N)) and the second formula is P_{Yi}=P_{Y0}+R*cos(i*360/N)) indicates the quantity of vertices of the first graphic, P_{Xi} indicates a horizontal coordinate of an i^{th} vertex in N vertices of the first graphic, P_{X0} indicates the horizontal coordinate of the central point of the first graphic, R indicates the radius of the first graphic, P_{Yi} indicates a vertical coordinate of the i^{th} vertex in the N vertices of the first graphic, P_{Y0} indicates the vertical coordinate of the central point of the first graphic, i indicates the i^{th} vertex in the N vertices of the first graphic, and i∈[1,N]. In this way, the mobile terminal can respectively obtain the horizontal coordinates of the vertices of the first graphic and the vertical coordinates of the vertices of the first graphic by using the first formula and the second formula.

In a sixth optional implementation of the first aspect, the location parameter of the first graphic further includes a width of the first graphic and a height of the first graphic, and the location parameter of the second UI includes coordinates of a central point of the second UI and coordinates of vertices of the second UI. A method for obtaining the location parameter of the second UI by the mobile terminal based on the location parameter of the first graphic includes: obtaining, by the mobile terminal, the coordinates of the central point of the second UI based on the coordinates of the central point of the first graphic, the width of the first graphic, and the height of the first graphic; and obtaining the coordinates of the vertices of the second UI based on the coordinates of the vertices of the first graphic, the width of the first graphic, and the height of the first graphic. In this way, the mobile terminal can obtain the related location parameter of the second UI based on the related location parameter of the first graphic.

In a seventh optional implementation of the first aspect, the coordinates of the central point of the first graphic include the horizontal coordinate of the central point of the first graphic and the vertical coordinate of the central point of the first graphic, the coordinates of the vertices of the first graphic include the horizontal coordinates of the vertices of the first graphic and the vertical coordinates of the vertices of the first graphic, the coordinates of the central point of the second UI include a horizontal coordinate of the central point of the second UI and a vertical coordinate of the central point of the second UI, and the coordinates of the vertices of the second UI include horizontal coordinates of the vertices of the second UI and vertical coordinates of the vertices of the second UI.

A method for obtaining the coordinates of the central point of the second UI by the mobile terminal based on the coordinates of the central point of the first graphic, the width of the first graphic, and the height of the first graphic includes: obtaining, by the mobile terminal, the horizontal coordinate of the central point of the second UI based on the horizontal coordinate of the central point of the first graphic and the width of the first graphic by using a third formula, and obtaining the vertical coordinate of the central point of the second UI based on the vertical coordinate of the central point of the first graphic and the height of the first graphic by using a fourth formula. The third formula is T_{X0}=P_{X0}/W, and the fourth formula is T_{T0}=P_{X0}/H. T_{X0} is the horizontal coordinate of the central point of the second UI, P_{X0} is the horizontal coordinate of the central point of the first graphic, W is the width of the first graphic, T_{Y0} is the vertical coordinate of the central point of the second UI, P_{X0} is the vertical coordinate of the central point of the first graphic, and H is the height of the first graphic. In this way, the mobile terminal can respectively obtain the horizontal coordinate of the central point of the second UI and the vertical coordinate of the central point of the second UI by using the third formula and the fourth formula.

In addition, a method for obtaining the coordinates of the vertices of the second UI by the mobile terminal based on the coordinates of the vertices of the first graphic, the width of the first graphic, and the height of the first graphic includes: obtaining, by the mobile terminal, the horizontal coordinates of the vertices of the second UI based on the horizontal coordinates of the vertices of the first graphic and the width of the first graphic by using a fifth formula, and obtaining the vertical coordinates of the vertices of the second UI based on the vertical coordinates of the vertices of the first graphic and the height of the first graphic by using a sixth formula.

The fifth formula is T_{Xi}=P_{Xi}/W, and the sixth formula T_{Yi}=P_{Yi}/H. T_{Xi} is a horizontal coordinate of an i^{th} vertex of the second UI, P_{Xi} is the horizontal coordinate of the i^{th} vertex of the first graphic, W is the width of the first graphic, T_{Yi} is a vertical coordinate of the i^{th} vertex of the second UI, P_{Yi} is the vertical coordinate of the i^{th} vertex of the first graphic, and H is the height of the first graphic. In this way, the mobile terminal can respectively obtain the horizontal coordinates of the vertices of the second UI and the vertical coordinates of the vertices of the second UI by using the fifth formula and the sixth formula.

In an eighth optional implementation of the first aspect, the second UI includes a plurality of frames of images. A method for obtaining the radius of the first graphic by the mobile terminal includes: when the mobile terminal displays each of the plurality of frames of images, obtaining, by the mobile terminal, a radius of the first graphic by performing the following steps: obtaining, by the mobile terminal, a parameter of a current frame of image, where the parameter of the current frame of image includes total duration of the plurality of frames of images, a first radius of the first graphic, and a second radius of the first graphic; and obtaining a radius of the first graphic based on the total duration of the plurality of frames of images, the first radius, and the second radius when the mobile terminal displays the current frame of image. The first radius is a radius of the first graphic when the mobile terminal displays a first frame of image in the plurality of frames of images, and the second radius is a radius of the first graphic when the mobile terminal displays a last frame of image in the plurality of frames of images. In this way, if the central point of the first graphic is fixed (in other words, a location of the central point of the first graphic in the first UI is fixed when the mobile terminal displays each of the plurality of frames of images of the second UI by using the first graphic), the mobile terminal can obtain, by using the method, the radius of the first graphic when the mobile terminal displays each of the plurality of frames of images of the second UI.

In a ninth optional implementation of the first aspect, the second UI includes a plurality of frames of images. A method for obtaining the coordinates of the central point of the first graphic and the radius of the first graphic by the mobile terminal includes: when the mobile terminal displays each of the plurality of frames of images, obtaining, by the mobile terminal, coordinates of a central point of the first graphic and a radius of the first graphic by performing the following steps: obtaining, by the mobile terminal, a parameter of a current frame of image, where the parameter of the current frame of image includes total duration of the plurality of frames of images, a first radius of the first graphic, a second radius of the first graphic, coordinates of a first central point of the first graphic, and coordinates of a second central point of the first graphic; obtaining coordinates of a central point of the first graphic based on the total duration of the plurality of frames of images, the coordinates of the first central point, and the coordinates of the second central point when the mobile terminal displays the current frame of image; and obtaining a radius of the first graphic based on the total duration of the plurality of frames of images, the first radius, and the second radius when the mobile terminal displays the current frame of image. The first radius is a radius of the first graphic when the mobile terminal displays a first frame of image in the plurality of frames of images, the second radius is a radius of the first graphic when the mobile terminal displays a last frame of image in the plurality of frames of images, the first central point is a central point of the first graphic when the mobile terminal displays the first frame of image, and the second central point is a central point of the first graphic when the mobile terminal displays the last frame of image. In this way, if the central point of the first graphic is variable (in other words, a location of the central point of the first graphic in the first UI is variable when the mobile terminal displays each of the plurality of frames of images of the second UI by using the first graphic), the mobile terminal can obtain, by using the method, the coordinates of the central point of the first graphic and the radius of the first graphic when the mobile terminal displays each of the plurality of frames of images of the second UI.

According to a second aspect, a mobile terminal is provided. The mobile terminal includes an obtaining module and a display module. The display module is configured to display a first UI. The obtaining module is configured to obtain a first instruction that is entered by a user in the first UI displayed by the display module and that is used to trigger the mobile terminal to perform a first operation. The display module is further configured to display, in response to the first instruction obtained by the obtaining module, a second UI (the second UI is a UI to be displayed after the mobile terminal performs the first operation) in the first UI by using a first graphic (the first graphic is predefined).

In a first optional implementation of the second aspect, the display module is specifically configured to dynamically display the second UI in the first UI by using the first graphic.

In a second optional implementation of the second aspect, the obtaining module is further configured to obtain a second instruction that is entered by the user and that is used to trigger the mobile terminal to select the first graphic.

In a third optional implementation of the second aspect, before the display module displays the second UI by using the first graphic, the obtaining module is further configured to obtain a location parameter of the first graphic and a location parameter of the second UI. Specifically, the obtaining module is specifically configured to: obtain the location parameter of the first graphic, and obtain the location parameter of the second UI based on the location parameter of the first graphic.

In a fourth optional implementation of the second aspect, the location parameter of the first graphic includes coordinates of a central point of the first graphic and coordinates of vertices of the first graphic. The obtaining module is specifically configured to: obtain the coordinates of the central point of the first graphic, a radius of the first graphic, and a quantity of vertices of the first graphic; and obtain the coordinates of the vertices of the first graphic based on the coordinates of the central point of the first graphic, the radius of the first graphic, and the quantity of vertices of the first graphic.

In a fifth optional implementation of the second aspect, the coordinates of the central point of the first graphic include a horizontal coordinate of the central point of the first graphic and a vertical coordinate of the central point of the first graphic, and the coordinates of the vertices of the first graphic include horizontal coordinates of the vertices of the first graphic and vertical coordinates of the vertices of the first graphic. The obtaining module is specifically configured to: obtain the horizontal coordinates of the vertices of the first graphic based on the horizontal coordinate of the central point of the first graphic, the radius of the first graphic, and the quantity of vertices of the first graphic by using a first formula; and obtain the vertical coordinates of the vertices of the first graphic based on the vertical coordinate of the central point of the first graphic, the radius of the first graphic, and the quantity of vertices of the first graphic by using a second formula. The first formula is P_{Xi}=P_{X0}+R*cos(i*360/N)), and the second formula is P_{Yi}=P_{Y0}+R*cos(i*360/N)). N indicates the quantity of vertices of the first graphic, P_{Xi} indicates a horizontal coordinate of an i^{th} vertex in N vertices of the first graphic, P_{X0} indicates the horizontal coordinate of the central point of the first graphic, R indicates the radius of the first graphic, P_{Yi} indicates a vertical coordinate of the i^{th} vertex in the N vertices of the first graphic, P_{Y0} indicates the vertical coordinate of the central point of the first graphic, i indicates the i^{th} vertex in the N vertices of the first graphic, and i∈[1,N].

In a sixth optional implementation of the second aspect, the location parameter of the first graphic further includes a width of the first graphic and a height of the first graphic, and the location parameter of the second UI includes coordinates of a central point of the second UI and coordinates of vertices of the second UI. The obtaining module is specifically configured to: obtain the coordinates of the central point of the second UI based on the coordinates of the central point of the first graphic, the width of the first graphic, and the height of the first graphic; and obtain the coordinates of the vertices of the second UI based on the coordinates of the vertices of the first graphic, the width of the first graphic, and the height of the first graphic.

In a seventh optional implementation of the second aspect, the coordinates of the central point of the first graphic include the horizontal coordinate of the central point of the first graphic and the vertical coordinate of the central point of the first graphic, the coordinates of the vertices of the first graphic include the horizontal coordinates of the vertices of the first graphic and the vertical coordinates of the vertices of the first graphic, the coordinates of the central point of the second UI include a horizontal coordinate of the central point of the second UI and a vertical coordinate of the central point of the second UI, and the coordinates of the vertices of the second UI include horizontal coordinates of the vertices of the second UI and vertical coordinates of the vertices of the second UI. The obtaining module is specifically configured to: obtain the horizontal coordinate of the central point of the second UI based on the horizontal coordinate of the central point of the first graphic and the width of the first graphic by using a third formula; obtain the vertical coordinate of the central point of the second UI based on the vertical coordinate of the central point of the first graphic and the height of the first graphic by using a fourth formula; obtain the horizontal coordinates of the vertices of the second UI based on the horizontal coordinates of the vertices of the first graphic and the width of the first graphic by using a fifth formula; and obtain the vertical coordinates of the vertices of the second UI based on the vertical coordinates of the vertices of the first graphic and the height of the first graphic by using a sixth formula. The third formula is T_{X0}=_{X0}/W, the fourth formula is T_{Y0}=P_{Y0}/H, the fifth formula is T_{Xi}=P_{Xi}/W, and the sixth formula is T_{Yi}=P_{Yi}/H. T_{X0} is the horizontal coordinate of the central point of the second UI, P_{X0} is the horizontal coordinate of the central point of the first graphic, W is the width of the first graphic, T_{Y0} is the vertical coordinate of the central point of the second UI, P_{Y0} is the vertical coordinate of the central point of the first graphic, H is the height of the first graphic, T_{Xi} is a horizontal coordinate of an i^{th} vertex of the second UI, P_{Xi} is the horizontal coordinate of the i^{th} vertex of the first graphic, T_{Yi} is a vertical coordinate of the i^{th} vertex of the second UI, and P_{Yi} is the vertical coordinate of the i^{th} vertex of the first graphic.

In an eighth optional implementation of the second aspect, the second UI includes a plurality of frames of images. The obtaining module is specifically configured to: when the display module displays each of the plurality of frames of images, obtain a radius of the first graphic by performing the following steps: obtaining a parameter of a current frame of image, where the parameter of the current frame of image includes total duration of the plurality of frames of images, a first radius of the first graphic, and a second radius of the first graphic; and obtaining a radius of the first graphic based on the total duration of the plurality of frames of images, the first radius, and the second radius when the display module displays the current frame of image. The first radius is a radius of the first graphic when the display module displays a first frame of image in the plurality of frames of images, and the second radius is a radius of the first graphic when the display module displays a last frame of image in the plurality of frames of images.

In a ninth optional implementation of the second aspect, the second UI includes a plurality of frames of images. The obtaining module is specifically configured to: when the display module displays each of the plurality of frames of images, obtain coordinates of a central point of the first graphic and a radius of the first graphic by performing the following steps: obtaining a parameter of a current frame of image, where the parameter of the current frame of image includes total duration of the plurality of frames of images, a first radius of the first graphic, a second radius of the first graphic, coordinates of a first central point of the first graphic, and coordinates of a second central point of the first graphic; obtaining coordinates of a central point of the first graphic based on the total duration of the plurality of frames of images, the coordinates of the first central point, and the coordinates of the second central point when the display module displays the current frame of image; and obtaining a radius of the first graphic based on the total duration of the plurality of frames of images, the first radius, and the second radius when the display module displays the current frame of image. The first radius is a radius of the first graphic when the display module displays a first frame of image in the plurality of frames of images, the second radius is a radius of the first graphic when the display module displays a last frame of image in the plurality of frames of images, the first central point is a central point of the first graphic when the display module displays the first frame of image, and the second central point is a central point of the first graphic when the display module displays the last frame of image.

According to a third aspect, a mobile terminal is provided. The mobile terminal includes a processor, a display, and a memory. The display is configured to display a first UI. The processor is configured to obtain a first instruction that is entered by a user in the first UI displayed by the display and that is used to trigger the mobile terminal to perform a first operation. The display is further configured to display, in response to the first instruction obtained by the processor, a second UI (the second UI is a UI to be displayed after the mobile terminal performs the first operation) in the first UI by using a first graphic (the first graphic is predefined). The memory is configured to store the first instruction.

In a first optional implementation of the third aspect, the display is specifically configured to dynamically display the second UI in the first UI by using the first graphic.

In a second optional implementation of the third aspect, the processor is further configured to obtain a second instruction that is entered by the user and that is used to trigger the mobile terminal to select the first graphic, and the memory is further configured to store the second instruction.

It may be understood that in this application, the processor may further perform the steps performed by the obtaining module in any one of the third to the ninth optional implementations of the second aspect. To avoid repetition, the steps are not listed herein again.

Optionally, in the first aspect to the third aspect, because the first instruction entered by the user varies, the second UI displayed by the mobile terminal also varies, and a dynamic change process of the first graphic and the second UI also varies when the mobile terminal displays the second UI by using the predefined first graphic. The following separately describes four cases (for example, Case 1, Case 2, Case 3, and Case 4 described below).

Case 1: The first instruction is an instruction for triggering the mobile terminal to open an application, and the second UI is an interface of the application. When the mobile terminal in the first aspect, the display module in the second aspect, or the display in the third aspect displays the second UI by using the first graphic, the first graphic and the second UI gradually expand by using the central point of the first graphic as a center, until the second UI covers the first UI.

Case 2: The first instruction is an instruction for triggering the mobile terminal to close an application, and the second UI is an interface of the application. When the mobile terminal in the first aspect, the display module in the second aspect, or the display in the third aspect displays the second UI by using the first graphic, the first graphic and the second UI gradually shrink towards the central point of the first graphic by using the central point of the first graphic as a center, until the first graphic and the second UI disappear.

Case 3: The first instruction is an instruction for triggering the mobile terminal to open a message prompt box, and the second UI is an interface of the message prompt box. When the mobile terminal in the first aspect, the display module in the second aspect, or the display in the third aspect displays the second UI by using the first graphic, the first graphic and the second UI gradually expand by using the central point of the first graphic as a center, until a shape of the first graphic becomes a predefined designated shape.

Case 4: The first instruction is an instruction for triggering the mobile terminal to close a message prompt box, and the second UI is an interface of the message prompt box. When the mobile terminal in the first aspect, the display module in the second aspect, or the display in the third aspect displays the second UI by using the first graphic, the first graphic and the second UI gradually shrink towards the central point of the first graphic by using the central point of the first graphic as a center, until the first graphic and the second UI disappear.

In this application, by using the four cases, when the user enters different first instructions, the mobile terminal (or the display module or the display in the mobile terminal) can dynamically display the second UI with different effects by using the predefined first graphic, to diversify a display effect of the second UI displayed by the mobile terminal.

Optionally, in the first aspect to the third aspect, when the mobile terminal in the first aspect, the display module in the second aspect, or the display in the third aspect displays the second UI by using the first graphic, the location of the central point of the first graphic in the first UI is fixed or variable. In this way, a display effect of the second UI dynamically displayed by the mobile terminal can be diversified.

Optionally, in the first aspect to the third aspect, when the mobile terminal in the first aspect, the display module in the second aspect, or the display in the third aspect displays the second UI by using the first graphic, transparency of the first graphic gradually changes from first transparency to second transparency. In this way, a display effect of the second UI dynamically displayed by the mobile terminal can be diversified.

Optionally, in the first aspect to the third aspect, when the mobile terminal in the first aspect, the display module in the second aspect, or the display in the third aspect displays the second UI by using the first graphic, a speed at which the mobile terminal, the display module, or the display displays the second UI by using the first graphic is adjustable. In this way, a display effect of the second UI dynamically displayed by the mobile terminal can be diversified.

According to a fourth aspect, a user interface on a mobile terminal is provided. The mobile terminal includes a display, a touch-sensitive surface, a memory, and one or more processors that execute one or more programs stored in the memory, and the user interface includes a first UI, a first graphic, and a second UI. The mobile terminal obtains a first instruction that is entered by a user in the first UI and that is used to trigger the mobile terminal to perform a first operation, and displays, in response to the first instruction, the second UI (the second UI is a UI to be displayed after the mobile terminal performs the first operation) in the first UI by using the first graphic (the first graphic is predefined).

In a first optional implementation of the fourth aspect, the second UI is dynamically displayed in the first UI by using the first graphic.

In a second optional implementation of the fourth aspect, in a process of displaying the second UI by using the first graphic, the first graphic and the second UI gradually expand by using a central point of the first graphic as a center, until the second UI covers the first UI.

In a third optional implementation of the fourth aspect, the first instruction is an instruction for triggering the mobile terminal to open an application, and the second UI is an interface of the application.

In a fourth optional implementation of the fourth aspect, in a process of displaying the second UI by using the first graphic, the first graphic and the second UI gradually expand by using a central point of the first graphic as a center, until a shape of the first graphic becomes a predefined designated shape.

In a fifth optional implementation of the fourth aspect, the first instruction is an instruction for triggering the mobile terminal to open a message prompt box, and the second UI is an interface of the message prompt box.

In a sixth optional implementation of the fourth aspect, in a process of displaying the second UI by using the first graphic, the first graphic and the second UI gradually shrink towards a central point of the first graphic by using the central point of the first graphic as a center, until the first graphic and the second UI disappear.

In a seventh optional implementation of the fourth aspect, the first instruction is an instruction for triggering the mobile terminal to close an application, and the second UI is an interface of the application; or the first instruction is an instruction for triggering the mobile terminal to close a message prompt box, and the second UI is an interface of the message prompt box.

In an eighth optional implementation of the fourth aspect, in the process of displaying the second UI by using the first graphic, a location of the central point of the first graphic in the first UI is fixed or variable.

In a ninth optional implementation of the fourth aspect, in the process of displaying the second UI by using the first graphic, transparency of the first graphic gradually changes from first transparency to second transparency.

In a tenth optional implementation of the fourth aspect, in the process of displaying the second UI by using the first graphic, a speed at which the second UI is displayed by using the first graphic is adjustable.

According to a fifth aspect, a computer-readable storage medium is provided. The computer-readable storage medium includes a computer instruction, and when the computer instruction runs on a mobile terminal, the mobile terminal performs the user interface display method performed by the mobile terminal in any one of the first aspect and the optional implementations of the first aspect.

Optionally, in the first aspect to the fifth aspect, the first graphic may be a regular polygon with N sides, N≥3, and N is an integer.

In this application, because the predefined first graphic may be any regular polygon, an effect of the second UI displayed by the mobile terminal can be diversified.

For descriptions of technical effects and other content of any one of the second aspect and the optional implementations of the second aspect, any one of the third aspect and the optional implementations of the third aspect, any one of the fourth aspect and the optional implementations of the fourth aspect, and the fifth aspect, refer to related descriptions of the technical effect and other content of any one of the first aspect and the optional implementations of the first aspect. Details are not described herein again.

### BRIEF DESCRIPTION OF DRAWINGS

FIG. 1 is an architectural diagram 1 of an Android operating system according to an embodiment of the present invention;

FIG. 2 is a schematic structural diagram of a mobile phone according to an embodiment of the present invention;

FIG. 3 is a schematic diagram 1 of a user interface display method according to an embodiment of the present invention;

FIG. 4 is a schematic diagram of displaying a second UI by a mobile terminal according to an embodiment of the present invention;

FIG. 5A and FIG. 5B are a schematic diagram 1 of dynamically displaying a second UI by a mobile terminal according to an embodiment of the present invention;

FIG. 6A and FIG. 6B are a schematic diagram 2 of dynamically displaying a second UI by a mobile terminal according to an embodiment of the present invention;

FIG. 7 is a schematic diagram of selecting a predefined first graphic by a user according to an embodiment of the present invention;

FIG. 8 is a schematic diagram of a predefined first graphic according to an embodiment of the present invention;

FIG. 9 is an architectural diagram 2 of an Android operating system according to an embodiment of the present invention;

FIG. 10 is a schematic structural diagram 1 of a mobile terminal according to an embodiment of the present invention; and

FIG. 11 is a schematic structural diagram 2 of a mobile terminal according to an embodiment of the present invention.

### DESCRIPTION OF EMBODIMENTS

The term “and/or” in this specification describes only an association relationship for describing associated objects and represents that three relationships may exist. For example, A and/or B may represent the following three cases: Only A exists, both A and B exist, and only B exists.

In the specification and claims of this application, the terms “first”, “second”, and the like are intended to distinguish between different objects instead of describing a particular order of the objects. For example, a first radius, a second radius, and the like are intended to distinguish between different radiuses, instead of describing a particular order of the radiuses.

The term such as “example” in the embodiments of the present invention is used to represent giving an example, an illustration, or a description. Any embodiment or design scheme described as an “example” in the embodiments of the present invention should not be explained as being more preferred or having more advantages than another embodiment or design scheme. Exactly, use of the term such as “example” is intended to present a related concept in a specific manner.

In the descriptions in the embodiments of the present invention, unless otherwise provided, “a plurality of” means two or more than two. For example, a plurality of processing modules are two or more processing modules. A meaning of “a plurality of frames” is two or more frames. For example, a plurality of frames of images are two or more frames of images.

Currently, because a UI displayed by a mobile terminal is usually a fixed rectangular UI, an effect of the UI displayed by the mobile terminal is not diversified enough.

To resolve the problem, the embodiments of the present invention provide a user interface display method, an apparatus, and a user interface. When a mobile terminal displays a first UI, the mobile terminal may display, in response to a first instruction entered by a user in the first UI, a second UI in the first UI by using a predefined first graphic. Therefore, in the embodiments of the present invention, the second UI displayed by the mobile terminal is not limited to a fixed rectangle. In this way, an effect of a UI displayed by the mobile terminal can be diversified.

The user interface display method, the apparatus, and the user interface provided in the embodiments of the present invention may be applied to a mobile terminal, and the mobile terminal may be a mobile terminal with an operating system. The operating system may be an Android operating system, an iOS operating system, or another possible operating system, and this is not limited in the embodiments of the present invention.

The following uses the Android operating system as an example to describe a software environment to which the user interface display method provided in the embodiments of the present invention is applied.

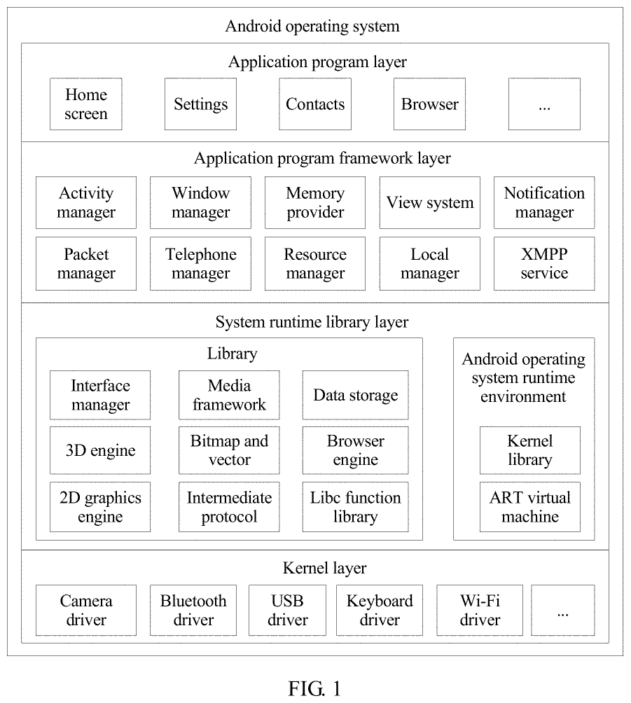

As shown in FIG. 1, FIG. 1 is a schematic architectural diagram of a possible Android operating system according to an embodiment of the present invention. In FIG. 1, an architecture of the Android operating system includes four layers: an application program layer, an application program framework layer, a system runtime library layer, and a kernel layer (which may be specifically a Linux kernel layer).

The application program layer is a set of application programs in the Android operating system. As shown in FIG. 1, the Android operating system provides numerous system application programs such as a home screen, settings, contacts, and a browser. In addition, an application program developer may also use the application program framework layer to develop another application program, for example, a third-party application program that can be installed and run on a mobile terminal.

The application program framework layer is actually an application program framework, and the developer may develop some application programs based on the application program framework layer when following a development rule of the application program framework. As shown in FIG. 1, some important components included in the application program framework layer include an activity manager, a window manager, a memory provider, a view system, a notification manager, a packet manager, a telephone manager, a resource manager, local management, an Extensible Messaging and Presence Protocol (extensible messaging and presence protocol, XMPP) service, and the like.

The system runtime library layer includes a library (also referred to as a system library) and an Android operating system runtime environment. As shown in

FIG. 1, the library mainly includes an interface manager, a media frame, data storage, a three-dimensional (three-dimensional, 3D) engine, a bitmap and a vector, a browser engine, a two-dimensional (two-dimensional, 2D) graphics engine, an intermediate protocol, and a libc function library (a function library of the C Programming Language). The Android operating system runtime environment includes an Android runtime environment (Android runtime, ART) virtual machine and a kernel library, and the ART virtual machine is configured to run an application program in the Android operating system based on the kernel library. For each application program in the Android operating system, one ART virtual machine serves the application program.

The kernel layer is an operating system layer of the Android operating system, and is a bottom-most layer in the Android operating system software layers. The kernel layer provides a core system service based on a Linux kernel. The kernel layer not only provides the core system service, but also provides a driver related to intelligent mobile terminal hardware, for example, a camera driver, a Bluetooth driver, a Universal Serial Bus (universal serial bus, USB) driver, a keyboard driver, and a Wireless Fidelity (wireless fidelity, Wi-Fi) driver shown in FIG. 1.

An Android operating system is used as an example. In the embodiments of the present invention, a developer may develop, based on the system architecture of the Android operating system shown in FIG. 1, the user interface display method provided in the embodiments of the present invention, so that the user interface display method can run based on the Android operating system shown in FIG. 1. Details are described in the following embodiments, and are not described herein again.

The mobile terminal provided in the embodiments of the present invention may be a terminal device such as a mobile phone, a tablet computer, a notebook computer, an ultra-mobile personal computer (ultra-mobile personal computer, UMPC), a netbook, a personal digital assistant (personal digital assistant, PDA), a smartwatch, or a smart band, or the mobile terminal may be another type of terminal device. This is not limited in the embodiments of the present invention.

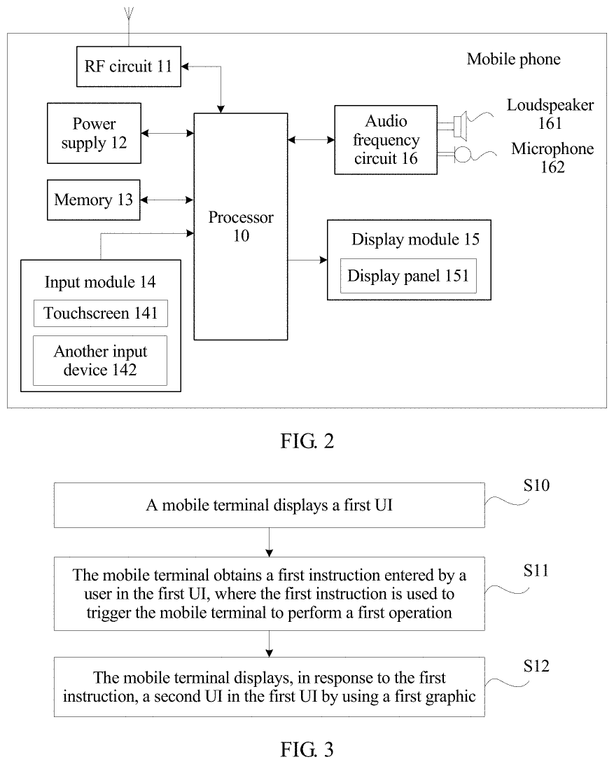

The following uses a mobile phone as an example of the mobile terminal provided in the embodiments of the present invention, to describe components of the mobile phone in detail with reference to FIG. 2.

For example, as shown in FIG. 2, the mobile phone provided in this embodiment of the present invention may include components such as a processor 10, a radio frequency (radio frequency, RF) circuit 11, a power supply 12, a memory 13, an input module 14, a display module 15, and an audio frequency circuit 16. A person skilled in the art may understand that a structure of the mobile phone shown in FIG. 2 does not constitute a limitation on a mobile phone, and the mobile phone may include more or fewer components than the components shown in FIG. 2, or may include a combination of some of the components shown in FIG. 2, or may include components disposed differently from the components shown in FIG. 2.

The processor 10 is a control center of the mobile phone, and is connected to each part of the entire mobile phone by using various interfaces and lines. The processor 10 performs various functions and data processing by running or executing a software program and/or a software module stored in the memory 13 and invoking data stored in the memory 13, so as to perform overall monitoring on the mobile phone. Optionally, the processor 10 may include one or more processing modules. For example, an application processor and a modem processor may be integrated into the processor 10. The application processor mainly processes an operating system, a user interface, an application program, and the like, and the modem processor mainly processes wireless communication. It may be understood that the modem processor may be a processor separated from the processor 10.

The RF circuit 11 may be configured to: receive and send information, or receive and send a signal in a call process. For example, after receiving downlink information from a base station, the RF circuit 11 sends the downlink information to the processor 10 for processing, and in addition, the RF circuit 11 sends uplink data to the base station. Generally, the RF circuit includes but is not limited to an antenna, at least one amplifier, a transceiver, a coupler, a low noise amplifier (low noise amplifier, LNA), a duplexer, and the like. In addition, the mobile phone may further implement wireless communication with another device in a network by using the RF circuit 11. Any communication standard or protocol may be used for the wireless communication, and the communication standard or protocol includes but is not limited to the Global System for Mobile Communications (global system of mobile communication, GSM), a general packet radio service (general packet radio service, GPRS), Code Division Multiple Access (code division multiple access, CDMA), Wideband Code Division Multiple Access (wideband code division multiple access, WCDMA), Long Term Evolution (long term evolution, LTE), an email, a short message service (short messaging service, SMS), and the like.

The power supply 12 may be configured to supply power to each component of the mobile phone, and the power supply 12 may be a battery. Optionally, the power supply may be logically connected to the processor 10 by using a power management system, so as to implement functions such as charging and discharging management and power consumption management by using the power management system.

The memory 13 may be configured to store a software program and/or a software module. The processor 10 performs various functional applications of the mobile phone and data processing by running the software program and/or the software module stored in the memory 13. The memory 13 may mainly include a program storage area and a data storage area. The program storage area may store an operating system, an application program required by at least one function (such as a sound play function or an image play function), and the like. The data storage area may store data (such as audio data, image data, or an address book) created based on use of the mobile phone, and the like. In addition, the memory 13 may include a high-speed random access memory, and may further include a nonvolatile memory, such as at least one magnetic disk storage component, a flash memory component, or another volatile solid-state storage component.

The input module 14 may be configured to: receive entered digital or character information, and generate key signal input related to user setting and function control of the mobile phone. Specifically, the input module 14 may include a touchscreen 141 and another input device 142. The touchscreen 141, also referred to as a touch panel, may collect a touch operation performed by a user on or near the touchscreen 141 (such as an operation performed by the user on or near the touchscreen 141 by using any proper object or accessory, such as a finger or a stylus), and drive a corresponding connection apparatus based on a preset program. Optionally, the touchscreen 141 may include two parts: a touch detection apparatus and a touch controller. The touch detection apparatus detects a touch orientation of the user, detects a signal brought by the touch operation, and transmits the signal to the touch controller. The touch controller receives touch information from the touch detection apparatus, converts the touch information into touch point coordinates, and sends the touch point coordinates to the processor 10, and can receive and execute a command sent by the processor 10. In addition, the touchscreen 141 may be implemented by using a plurality of types such as a resistive type, a capacitive type, an infrared ray, and a surface acoustic wave. The another input device 142 may include but is not limited to one or more of a physical keyboard, a function key (such as a volume control key or an on/off key), a trackball, a mouse, a joystick, and the like.

The display module 15 may be configured to display information entered by the user or information provided for the user, and various menus of the mobile phone. The display module 15 may include a display panel 151. Optionally, the display panel 151 may be configured in a form of a liquid crystal display (liquid crystal display, LCD), an organic light-emitting diode (organic light-emitting diode, OLED), or the like. Further, the touchscreen 141 may cover the display panel 151. After detecting a touch operation on or near the touchscreen 141, the touchscreen 141 transmits the touch operation to the processor 10 to determine a type of a touch event, and then the processor 10 provides corresponding visual output on the display panel 151 based on the type of the touch event. Although the touchscreen 141 and the display panel 151 in FIG. 2 are used as two independent components to implement input and output functions of the mobile phone, in some embodiments, the touchscreen 141 and the display panel 151 may be integrated to implement the input and output functions of the mobile phone.

The audio frequency circuit 16, a loudspeaker 161, and a microphone 162 are configured to provide an audio interface between the user and the mobile phone. The audio frequency circuit 16 may transmit an electrical signal converted from received audio data to the loudspeaker 161, and the loudspeaker 161 converts the electrical signal into a sound signal for output. In addition, the microphone 162 converts a collected sound signal into an electrical signal, and the audio frequency circuit 16 receives the electrical signal, converts the electrical signal into audio data, and then outputs the audio data to the RF circuit 11 by using the processor 10, so that the audio data is sent to, for example, another mobile phone, or the audio data is output, by using the processor 10, to the memory 13 for further processing.

Optionally, the mobile phone shown in FIG. 2 may further include various sensors, for example, a gyro sensor, a hygrometer sensor, an infrared sensor, and a magnetometer sensor, and details are not described herein.

Optionally, the mobile phone shown in FIG. 2 may further include a Wi-Fi module, a Bluetooth module, and the like, and details are not described herein.

The user interface display method provided in the embodiments of the present invention may be applied to a mobile terminal, or may be applied to another terminal device, for example, with an operating system, and this is not limited in the embodiments of the present invention. The following uses an example in which the user interface display method provided in the embodiments of the present invention is applied to the mobile terminal, to describe the user interface display method.

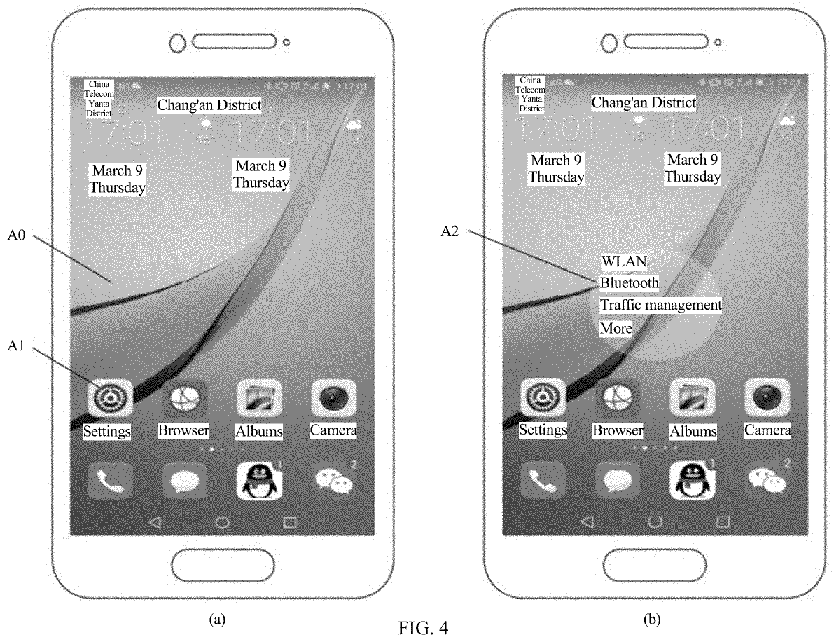

As shown in FIG. 3, an embodiment of the present invention provides a user interface display method. The display method may include S10 to S12 described below.

S10. A mobile terminal displays a first UI.

It may be understood that the first UI displayed by the mobile terminal may be a user interface currently displayed by the mobile terminal (referred to as a current user interface of the mobile terminal below). For example, the first UI displayed by the mobile terminal may be a home screen of the mobile terminal.

S11. The mobile terminal obtains a first instruction entered by a user in the first UI, where the first instruction is used to trigger the mobile terminal to perform a first operation.

S12. The mobile terminal displays, in response to the first instruction, a second UI in the first UI by using a first graphic.

The first graphic is a predefined graphic, and the second UI is a UI to be displayed after the mobile terminal performs the first operation.

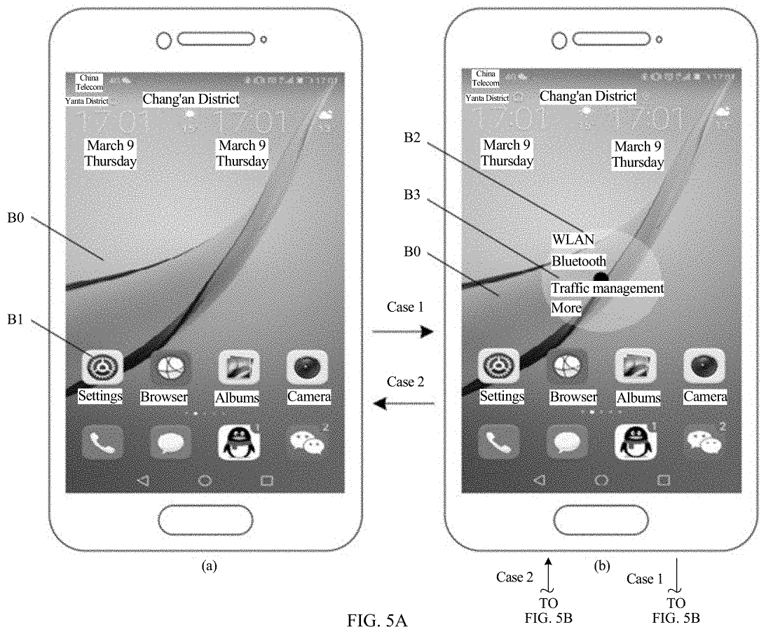

For example, the first UI is the home screen of the mobile terminal, the predefined first graphic is a circle, the first instruction is that the user taps an icon of a “Settings” application on the home screen of the mobile terminal, the first operation that the first instruction triggers the mobile terminal to perform is to open the “Settings” application, and the second UI is an interface of the “Settings” application displayed after the mobile terminal opens the “Settings” application. As shown in FIG. 4, FIG. 4 is a schematic diagram of displaying a user interface by a mobile terminal according to an embodiment of the present invention. In (a) in FIG. 4, the first UI displayed by the mobile terminal is the home screen (for example, A0 shown in (a) in FIG. 4) of the mobile terminal. After the user taps the icon of the “Settings” application on the home screen of the mobile terminal (that is, the first instruction, for example, A1 shown in (a) in FIG. 4), the mobile terminal may obtain the first instruction and open the “Settings” application in response to the first instruction. After the mobile terminal opens the “Settings” application, the mobile terminal may display an interface (that is, the second UI, for example, A2 shown in (b) in FIG. 4) of the “Settings” application on the home screen of the mobile terminal by using a circle.

According to the user interface display method provided in this embodiment of the present invention, when the mobile terminal displays the first UI, the mobile terminal may display, in response to the first instruction entered by the user in the first UI, the second UI in the first UI by using the predefined first graphic. Therefore, in this embodiment of the present invention, the second UI displayed by the mobile terminal is not limited to a fixed rectangle. In this way, an effect of a UI displayed by the mobile terminal can be diversified.

Optionally, in this embodiment of the present invention, the mobile terminal may dynamically display the second UI in the first UI by using the first graphic. In this way, an effect of a UI displayed by the mobile terminal can be further diversified.

For example, in this embodiment of the present invention, a process in which the mobile terminal dynamically displays the second UI in the first UI by using the first graphic may include: when the mobile terminal displays the second UI in the first UI by using the first graphic, the first graphic and the second UI may gradually expand by using a central point of the first graphic as a center, until the second UI covers the first UI (in other words, the second UI is displayed on a screen of the mobile terminal in full screen) or until a shape of the first graphic becomes a predefined designated shape; or when the mobile terminal displays the second UI in the first UI by using the first graphic, the first graphic and the second UI gradually shrink towards a central point of the first graphic by using the central point of the first graphic as a center, until the first graphic and the second UI disappear (in other words, the first graphic and the second UI completely disappear on a screen of the mobile terminal, and the first mobile terminal resumes displaying the first UI).

Optionally, in this embodiment of the present invention, that the first graphic and the second UI gradually expand by using the central point of the first graphic as a center may be specifically implemented by the mobile terminal by continuously displaying a plurality of frames of images (specifically, a plurality of frames of images of the second UI).

Optionally, in this embodiment of the present invention, that the first graphic and the second UI gradually shrink towards the central point of the first graphic by using the central point of the first graphic as a center may be specifically implemented by the mobile terminal by continuously displaying a plurality of frames of images (specifically, a plurality of frames of images of the second UI).

Optionally, in this embodiment of the present invention, because the first instruction entered by the user varies, the second UI displayed by the mobile terminal also varies, and a dynamic change process of the first graphic and the second UI also varies when the mobile terminal displays the second UI by using the predefined first graphic. The following separately uses four cases (for example, Case 1, Case 2, Case 3, and Case 4 described below) as an example, to describe the process in which the mobile terminal dynamically displays the second UI in the first UI by using the predefined first graphic in this embodiment of the present invention with reference to some accompanying drawings.

Case 1: The first instruction is an instruction for triggering the mobile terminal to open an application, and the second UI is an interface of the application. When the mobile terminal displays the second UI by using the first graphic, the first graphic and the second UI gradually expand by using a central point of the first graphic as a center, until the second UI covers the first UI (that is, the UI currently displayed by the mobile terminal).

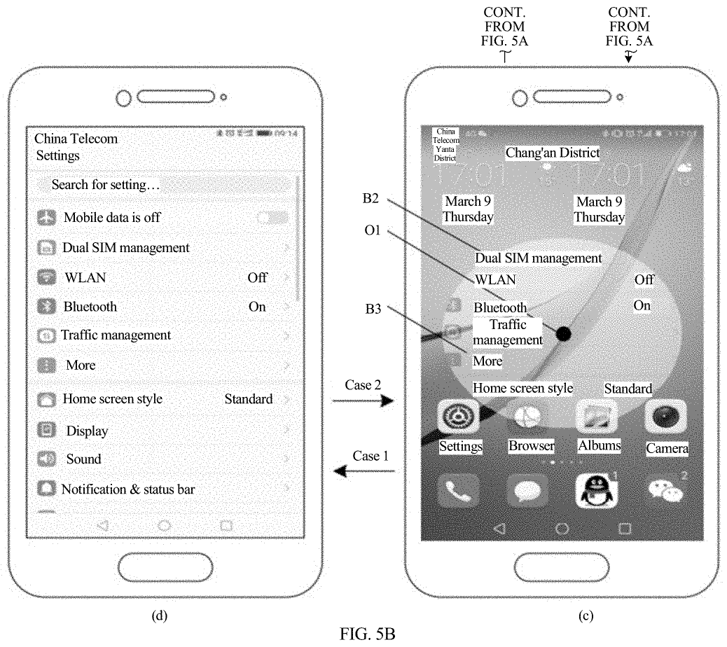

For example, the first UI is the home screen of the mobile terminal, the predefined first graphic is a circle, the first instruction is that the user taps an icon of a “Settings” application on the home screen of the mobile terminal (in other words, the first instruction is an instruction for triggering the mobile terminal to open the “Settings” application), and the second UI is an interface of the “Settings” application displayed after the mobile terminal opens the “Settings” application. As shown in FIG. 5A and FIG. 5B, FIG. 5A and FIG. 5B are a schematic diagram of a process in which a mobile terminal dynamically displays a second UI in a first UI by using a predefined first graphic according to an embodiment of the present invention. As shown in (a) in FIG. 5A and FIG. 5B, the first UI displayed by the mobile terminal is a home screen B0 of the mobile terminal. In this case, after the user taps an icon B1 of a “Settings” application on the home screen B0 of the mobile terminal, as shown in (b) in FIG. 5A and FIG. 5B, the mobile terminal displays an interface B3 of the “Settings” application on the home screen B0 of the mobile terminal by using a predefined circle B2. Then, as shown in (c) in FIG. 5A and FIG. 5B, the mobile terminal controls the circle B2 and the interface B3 of the “Settings” application to gradually expand by using a central point O1 of the circle B2 as a center. The mobile terminal continues to control the circle B2 and the interface B3 of the “Settings” application shown in (c) in FIG. 5A and FIG. 5B to gradually expand by using the central point O1 of the circle B2 as a center, until the interface B3 of the “Settings” application covers the home screen of the mobile terminal, in other words, the mobile terminal finally displays the interface B3 of the “Settings” application in full screen, as shown in (d) in FIG. 5A and FIG. 5B.

In this embodiment of the present invention, in the process, as shown in FIG. 5A and FIG. 5B, in which the mobile terminal dynamically displays the second UI in the first UI by using the predefined first graphic, it may be considered that the mobile terminal dynamically displays one frame of image of the second UI each time the mobile terminal dynamically displays the second UI. Therefore, continuously displaying all frames of images of the second UI by the mobile terminal can implement the dynamic change process of (b) to (c) and then to (d) in FIG. 5A and FIG. 5B.

It may be understood that FIG. 5A and FIG. 5B provide descriptions only by using an example in which the mobile terminal continuously displays three frames of images of the interface of the “Settings” application (for example, (b) in FIG. 5A and FIG. 5B is that the mobile terminal displays a first frame of image of the interface of the “Settings” application, (c) in FIG. 5A and FIG. 5B is that the mobile terminal displays a second frame of image of the interface of the “Settings” application, and (d) in FIG. 5A and FIG. 5B is that the mobile terminal displays a third frame of image of the interface of the “Settings” application). In actual implementation, the interface that is of the “Settings” application and that is continuously displayed by the mobile terminal may include at least three frames of images, and a display process of each frame of image is similar to (b), (c), or (d) in FIG. 5A and FIG. 5B. Details are not described herein again.

Optionally, when the mobile terminal displays the second UI in the first UI by using the first graphic, transparency of the first graphic may gradually change from first transparency to second transparency. The first transparency may be greater than the second transparency.

For example, in this embodiment of the present invention, when the mobile terminal dynamically displays each frame of image of the second UI in the first UI by using the predefined first graphic, the mobile terminal may control transparency of displaying each frame of image of the second UI. For example, as shown in (b) in FIG. 5A and FIG. 5B, when the mobile terminal displays the first frame of image of the interface of the “Settings” application by using a circle, the mobile terminal may control transparency of displaying the first frame of image to be X1 (that is, the first transparency); as shown in (c) in FIG. 5A and FIG. 5B, when the mobile terminal continues to display the second frame of image of the interface of the

“Settings” application by using a circle, the mobile terminal may control transparency of displaying the second frame of image to be X2 (that is, transparency between the first transparency and the second transparency); as shown in (d) in FIG. 5A and FIG. 5B, when the mobile terminal continues to display the third frame of image of the interface of the “Settings” application by using a circle, the mobile terminal may control transparency of displaying the third frame of image to be X3 (that is, the second transparency), where 0%≤X1, X2, X3≤100%, and X1>X2>X3. For example, X1 may be 70%, X2 may be 50%, and X3 may be 0%.

In other words, when the mobile terminal continuously displays all the frames of images of the second UI by using the predefined first graphic, the mobile terminal may control transparency of the second UI displayed by the mobile terminal to gradually change to be smaller, until the transparency of the second UI may be 0%, in other words, the second UI displayed by the mobile terminal is completely non-transparent when the mobile terminal displays a last frame of image of the second UI. In this way, after the mobile terminal displays the second UI in full screen (the mobile terminal can display the second UI in full screen after completing displaying the last frame of image of the second UI), the user may be protected against interference from another application or interface when operating the second UI.

Optionally, in this embodiment of the present invention, when the mobile terminal displays the second UI in the first UI by using the first graphic, a location of the central point of the first graphic in the first UI is fixed or variable.

In this embodiment of the present invention, the mobile terminal may dynamically display the second UI at a fixed location of the first UI by using the first graphic, or may dynamically display the second UI at different locations of the first UI by using the first graphic. In this way, a display effect of the second UI displayed by the mobile terminal can be further diversified.

Optionally, in this embodiment of the present invention, when the mobile terminal displays the second UI in the first UI by using the first graphic, a speed at which the mobile terminal displays the second UI by using the first graphic is adjustable.

In this embodiment of the present invention, the mobile terminal may dynamically display the second UI by using the first graphic at a relatively high speed, or may dynamically display the second UI by using the first graphic at a relatively low speed. Specifically, the speed at which the mobile terminal displays the second UI by using the first graphic may be set by the user. For example, a plurality of different speeds may be set in underlying software of a user interface (for example, three speeds V1, V2, and V3 may be set, where V1>V2>V3), and the user may select a speed from the plurality of different speeds based on corresponding options displayed in the user interface, so that the mobile terminal can dynamically display the second UI by using the first graphic at the speed selected by the user.

Optionally, in this embodiment of the present invention, the predefined first graphic may be a regular polygon with N sides, N≥3, and N is an integer. For example, the regular polygon with N sides may be any regular polygon that meets an actual requirement, such as a regular quadrilateral, a regular pentagon, a regular hexagon, or a regular octagon. This is not specifically limited in this embodiment of the present invention.

It may be understood that, when a quantity of sides of the regular polygon with N sides is relatively large, for example, when the quantity N of sides of the regular polygon with N sides is 360, the regular polygon with N sides may be approximately considered as a circle.

Case 2: The first instruction is an instruction for triggering the mobile terminal to close an application, and the second UI is an interface of the application. When the mobile terminal displays the second UI by using the first graphic, the first graphic and the second UI gradually shrink towards a central point of the first graphic by using the central point of the first graphic as a center, until the first graphic and the second UI disappear.

For example, the process in which the mobile terminal dynamically displays the second UI by using the predefined first graphic in Case 2 may be an inverse process of the process in which the mobile terminal dynamically displays the second UI by using the predefined first graphic in Case 1. Specifically, as shown in FIG. 5A and FIG. 5B, in Case 1, the process in which the mobile terminal dynamically displays the second UI by using the predefined first graphic may be from (a) to (b), to (c), and then to (d) in FIG. 5A and FIG. 5B. In Case 2, the process in which the mobile terminal dynamically displays the second UI by using the predefined first graphic may be from (d) to (c), to (b), and then to (a) in FIG. 5A and FIG. 5B. To be specific, in Case 2, after the mobile terminal continuously displays all frames of images of the second UI, the first graphic and the second UI finally disappear on a screen of the mobile terminal, in other words, the home screen of the mobile terminal is displayed on the screen of the mobile terminal after the mobile terminal completes displaying a last frame of image of the second UI (in other words, the mobile terminal resumes displaying the first UI, for example, BO shown in (a) in FIG. 5A and FIG. 5B).

In Case 2, initially, the second UI displayed by the mobile terminal completely covers the first UI (it may be considered that the mobile terminal displays the first UI and the second UI through complete superimposition). Therefore, assuming that the first UI displayed by the mobile terminal is still the home screen of the mobile terminal, and the second UI is an interface that is of a “Settings” application and that is completely superimposed on the first UI, the first instruction may be that the user taps a “Home (home)” key or a “Return” key, in other words, the first instruction is an instruction for triggering the mobile terminal to close the “Settings” application.

It should be noted that for specific descriptions of the process in which the mobile terminal dynamically displays the second UI by using the predefined first graphic in Case 2, refer to related descriptions of (a), (b), (c), and (d) in FIG. 5A and FIG. 5B in Case 1, and details are not described herein again.

In this embodiment of the present invention, when the mobile terminal dynamically displays the second UI in the first UI by using the predefined first graphic, it may be considered that the mobile terminal dynamically displays one frame of image of the second UI each time the mobile terminal dynamically displays the second UI. Therefore, continuously displaying all the frames of images of the second UI by the mobile terminal can implement the dynamic change process of (d) to (c) and then to (b) in FIG. 5A and FIG. 5B.

Optionally, in this embodiment of the present invention, when the mobile terminal dynamically displays each frame of image of the second UI by using the predefined first graphic, the mobile terminal may further control transparency of displaying each frame of image of the second UI. For specific descriptions of displaying, by the mobile terminal, all the frames of images of the second UI with different transparency, refer to related descriptions of displaying, by the mobile terminal, all the frames of images of the second UI with different transparency in Case 1, and details are not described herein again. A difference between Case 1 and Case 2 is that the first transparency is greater than the second transparency in Case 1, and the first transparency is less than the second transparency in Case 2.

For specific descriptions of a case in which a location of the central point of the first graphic in the first UI is fixed or variable, refer to related descriptions of the case in which the location of the central point of the first graphic in the first UI is fixed or variable in Case 1, and details are not described herein again.

For specific descriptions of a case in which a speed at which the mobile terminal displays the second UI by using the first graphic is adjustable, refer to related descriptions of the case in which the speed at which the mobile terminal displays the second UI by using the first graphic is adjustable in Case 1, and details are not described herein again.

For specific descriptions of the predefined first graphic, refer to related descriptions of the predefined first graphic in Case 1, and details are not described herein again.

Case 3: The first instruction is an instruction for triggering the mobile terminal to open a message prompt box, and the second UI is an interface of the message prompt box. When the mobile terminal displays the second UI by using the first graphic, the first graphic and the second UI gradually expand by using a central point of the first graphic as a center, until a shape of the first graphic becomes a predefined designated shape.

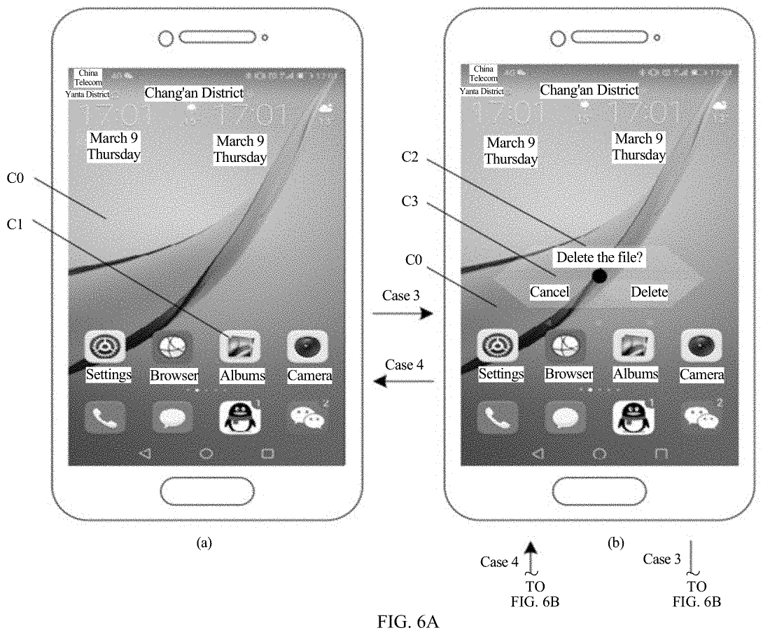

For example, the first UI is an interface for displaying each file by the mobile terminal, the predefined first graphic is a regular hexagon, the designated shape is a round rectangle, the first instruction is that the user touches and holds an icon of a file to delete the file (in other words, the first instruction is an instruction for triggering the mobile terminal to display a message prompt box indicating whether to delete the file), and the second UI is an interface that is of the message prompt box and that is displayed after the mobile terminal displays the message prompt box. As shown in FIG. 6A and FIG. 6B, FIG. 6A and FIG. 6B are a schematic diagram of a process in which a mobile terminal dynamically displays a second UI in a first UI by using a predefined first graphic according to an embodiment of the present invention. As shown in (a) in FIG. 6A and FIG. 6B, the first UI displayed by the mobile terminal is an interface C0 for displaying each file by the mobile terminal. In this case, after the user touches and holds an icon C1 of a “file 1” in the interface C0 of the mobile terminal, as shown in (b) in FIG. 6A and FIG. 6B, the mobile terminal displays, by using a predefined regular hexagon C2, an interface C3 of the message prompt box in the interface C0 for displaying each file by the mobile terminal. Then, as shown in (c) in FIG. 6A and FIG. 6B, the mobile terminal controls the regular hexagon C2 and the interface C3 of the message prompt box to gradually expand by using a central point O2 of the regular hexagon C2 as a center. The mobile terminal continues to control the regular hexagon C2 and the interface C3 of the message prompt box shown in (c) in FIG. 6A and FIG. 6B to gradually expand by using the central point O2 of the regular hexagon C2 as a center, until the regular hexagon C2 changes into a round rectangle C4, in other words, the mobile terminal finally displays the interface of the message prompt box by using the designated round rectangle C4, as shown in (d) in FIG. 6A and FIG. 6B.

In this embodiment of the present invention, in the process, as shown in FIG. 6A and FIG. 6B, in which the mobile terminal dynamically displays the second UI in the first UI by using the predefined first graphic, it may be considered that the mobile terminal dynamically displays one frame of image of the second UI each time the mobile terminal dynamically displays the second UI. Therefore, continuously displaying all frames of images of the second UI by the mobile terminal can implement the dynamic change process of (b) to (c) and then to (d) in FIG. 6A and FIG. 6B.

It may be understood that FIG. 6A and FIG. 6B provide descriptions only by using an example in which the mobile terminal continuously displays three frames of images of the interface of the message prompt box (for example, (b) in FIG. 6A and FIG. 6B is that the mobile terminal displays a first frame of image of the interface of the message prompt box, (c) in FIG. 6A and FIG. 6B is that the mobile terminal displays a second frame of image of the interface of the message prompt box, and (d) in FIG. 6A and FIG. 6B is that the mobile terminal displays a third frame of image of the interface of the message prompt box). In actual implementation, the interface that is of the message prompt box and that is continuously displayed by the mobile terminal may include at least three frames of images, and a display process of each frame of image is similar to (b), (c), or (d) in FIG. 6A and FIG. 6B. Details are not described herein again.

Optionally, when the mobile terminal displays the second UI in the first UI by using the first graphic, transparency of the first graphic may gradually change from first transparency to second transparency. The first transparency may be greater than the second transparency.

For example, in this embodiment of the present invention, when the mobile terminal dynamically displays each frame of image of the second UI in the first UI by using the predefined first graphic, the mobile terminal may control transparency of displaying each frame of image of the second UI. For specific descriptions of displaying, by the mobile terminal, all the frames of images of the second UI with different transparency, refer to related descriptions of displaying, by the mobile terminal, all the frames of images of the second UI with different transparency in Case 1, and details are not described herein again.

For specific descriptions of a case in which a location of the central point of the first graphic in the first UI is fixed or variable, refer to related descriptions of the case in which the location of the central point of the first graphic in the first UI is fixed or variable in Case 1, and details are not described herein again.

For specific descriptions of a case in which a speed at which the mobile terminal displays the second UI by using the first graphic is adjustable, refer to related descriptions of the case in which the speed at which the mobile terminal displays the second UI by using the first graphic is adjustable in Case 1, and details are not described herein again.

For specific descriptions of the predefined first graphic, refer to related descriptions of the predefined first graphic in Case 1, and details are not described herein again.

Case 4: The first instruction is an instruction for triggering the mobile terminal to close a message prompt box, and the second UI is an interface of the message prompt box. When the mobile terminal displays the second UI by using the first graphic, the first graphic and the second UI gradually shrink towards a central point of the first graphic by using the central point of the first graphic as a center, until the first graphic and the second UI disappear.

For example, the process in which the mobile terminal dynamically displays the second UI by using the predefined first graphic in Case 4 may be an inverse process of the process in which the mobile terminal dynamically displays the second UI by using the predefined first graphic in Case 3. Specifically, as shown in FIG. 6A and FIG. 6B, in Case 3, the process in which the mobile terminal dynamically displays the second UI by using the predefined first graphic may be from (a) to (b), to (c), and then to (d) in FIG. 6A and FIG. 6B. In Case 4, the process in which the mobile terminal dynamically displays the second UI by using the predefined first graphic may be from (d) to (c), to (b), and then to (a) in FIG. 6A and FIG. 6B. To be specific, in Case 4, after the mobile terminal continuously displays all frames of images of the second UI, the first graphic and the second UI finally disappear on a screen of the mobile terminal, in other words, an interface for displaying each file by the mobile terminal is displayed on the screen of the mobile terminal after the mobile terminal completes displaying a last frame of image of the second UI (in other words, the mobile terminal resumes displaying the first UI, for example, C0 shown in (a) in FIG. 6A and FIG. 6B).

In Case 4, initially, the second UI displayed by the mobile terminal is superimposed on the first UI (it may be considered that the mobile terminal displays the first UI and the second UI through superimposition). Therefore, assuming that the first UI displayed by the mobile terminal is an interface obtained after the interface of the message prompt box is superimposed on the home screen of the mobile terminal (for example, as shown in (d) in FIG. 6A and FIG. 6B), and the second interface is the interface of the message prompt box, the first instruction may be that the user taps a “Delete” or “Cancel” button in the message prompt box shown in (d) in FIG. 6A and FIG. 6B, in other words, the first instruction is an instruction for triggering the mobile terminal to close the message prompt box.

It should be noted that for specific descriptions of the process in which the mobile terminal dynamically displays the second UI by using the predefined first graphic in Case 4, refer to related descriptions of (a), (b), (c), and (d) in FIG. 6A and FIG. 6B in Case 3, and details are not described herein again.

In this embodiment of the present invention, when the mobile terminal dynamically displays the second UI in the first UI by using the predefined first graphic, it may be considered that the mobile terminal dynamically displays one frame of image of the second UI each time the mobile terminal dynamically displays the second UI. Therefore, continuously displaying all the frames of images of the second UI by the mobile terminal can implement the dynamic change process of (d) to (c) and then to (b) in FIG. 6A and FIG. 6B.

Optionally, in this embodiment of the present invention, when the mobile terminal dynamically displays each frame of image of the second UI by using the predefined first graphic, the mobile terminal may further control transparency of displaying each frame of image of the second UI. For specific descriptions of displaying, by the mobile terminal, all the frames of images of the second UI with different transparency, refer to related descriptions of displaying, by the mobile terminal, all the frames of images of the second UI with different transparency in Case 1, and details are not described herein again. A difference between Case 1 and Case 4 is that the first transparency is greater than the second transparency in Case 1, and the first transparency is less than the second transparency in Case 4.

It may be understood that the first transparency is greater than the second transparency in Case 1 and Case 3, and the first transparency is less than the second transparency in Case 2 and Case 4.

For specific descriptions of a case in which a location of the central point of the first graphic in the first UI is fixed or variable, refer to related descriptions of the case in which the location of the central point of the first graphic in the first UI is fixed or variable in Case 1, and details are not described herein again.

In Case 3 and Case 4, a central point of the message prompt box displayed by the mobile terminal may be a point that the user touches on the screen of the mobile terminal. It should be noted that, if the location of the central point of the first graphic in the first UI is variable, an initial central point of the message prompt box displayed by the mobile terminal may be a point that the user touches on the screen of the mobile terminal.

For specific descriptions of a case in which a speed at which the mobile terminal displays the second UI by using the first graphic is adjustable, refer to related descriptions of the case in which the speed at which the mobile terminal displays the second UI by using the first graphic is adjustable in Case 1, and details are not described herein again.

For specific descriptions of the predefined first graphic, refer to related descriptions of the predefined first graphic in Case 1, and details are not described herein again.

According to the user interface display method provided in this embodiment of the present invention, when the mobile terminal displays the first UI, the mobile terminal may display, in response to the first instruction entered by the user in the first UI, the second UI in the first UI by using the predefined first graphic; and when the mobile terminal displays the second UI by using the first graphic, the first graphic and the second UI may be displayed with an effect of gradually expanding or with an effect of gradually shrinking towards the central point of the first graphic. Therefore, the second UI can be dynamically displayed by the mobile terminal by using the predefined first graphic, instead of being limited to a fixed rectangle. In this way, an effect of a UI displayed by the mobile terminal can be diversified.

Optionally, with reference to FIG. 3, the user interface display method provided in this embodiment of the present invention may further include S13.

S13. The mobile terminal obtains a second instruction entered by the user, where the second instruction is used to trigger the mobile terminal to select the first graphic.

In this embodiment of the present invention, an option used by the user to select the first graphic may be added to the “Settings” application in the mobile terminal. The option may include a plurality of first graphics (for example, a regular quadrilateral, a regular hexagon, and a circle). The user selects a first graphic from the option in the “Settings” application (that is, the second instruction), to trigger the mobile terminal to select the first graphic, so that after the user enters the first instruction, the mobile terminal can display, by using the selected first graphic, the second UI displayed after the mobile terminal responds to the first instruction.

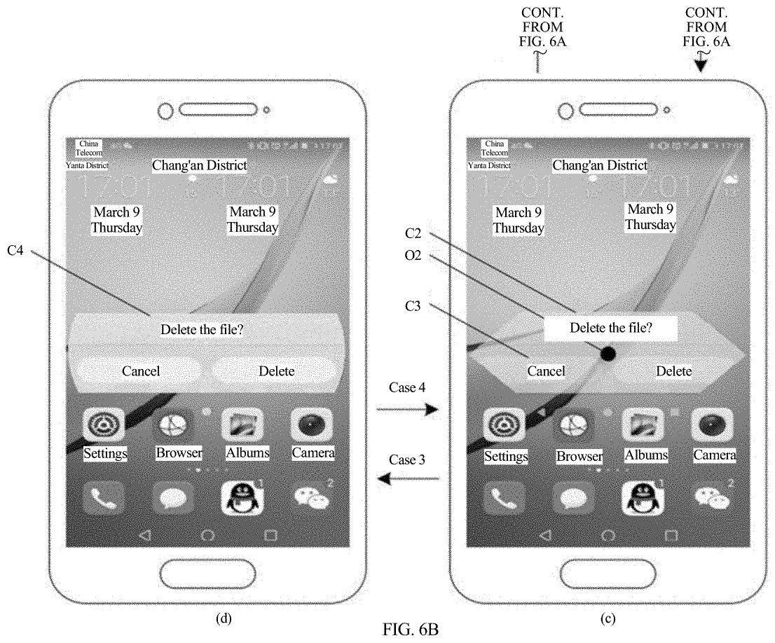

For example, as shown in FIG. 7, an option of “Graphics displayed in the user interface” is added to a “Display” option (as shown in a dashed-line box in (a) in FIG. 7) in the “Settings” application, and options of “Regular quadrilateral”, “Regular hexagon”, and “Circle” are set in the option of “Graphics displayed in the user interface” (as shown in (b) in FIG. 7). In this case, the user may enable a graphic to select the graphic in the user interface shown in (b) in FIG. 7 (that is, the user enters the second instruction). In this way, the user can select the graphic, to trigger the mobile terminal to select the graphic, so that after the user enters the first instruction, the mobile terminal can display, by using the graphic selected by the user, the second UI displayed after the mobile terminal responds to the first instruction.

It may be understood that in this embodiment of the present invention, S13 may be specifically performed before S11. For example, S13 may be performed when the mobile terminal performs S10.

Optionally, with reference to FIG. 3, the user interface display method provided in this embodiment of the present invention may further include S110 and S111 before S12. It may be understood that, after the mobile terminal obtains a location parameter of the first graphic and a location parameter of the second UI by performing S110 and S111, the mobile terminal may display, based on the location parameter of the first graphic and the location parameter of the second UI by using the first graphic, the second UI in the first UI displayed by the mobile terminal (the mobile terminal may specifically perform S12 based on the location parameter of the first graphic and the location parameter of the second UI).

S110. The mobile terminal obtains a location parameter of the first graphic.

S111. The mobile terminal obtains a location parameter of the second UI based on the location parameter of the first graphic.

Optionally, in this embodiment of the present invention, the location parameter of the first graphic may include coordinates of the central point of the first graphic and coordinates of vertices of the first graphic. In this case, S110 may be specifically implemented by performing S110a and S110b.

S110a. The mobile terminal obtains coordinates of a central point of the first graphic, a radius of the first graphic, and a quantity of vertices of the first graphic.

In this embodiment of the present invention, because the first graphic is predefined, the coordinates of the central point of the first graphic, the radius of the first graphic, and the quantity of vertices of the first graphic may be predefined.

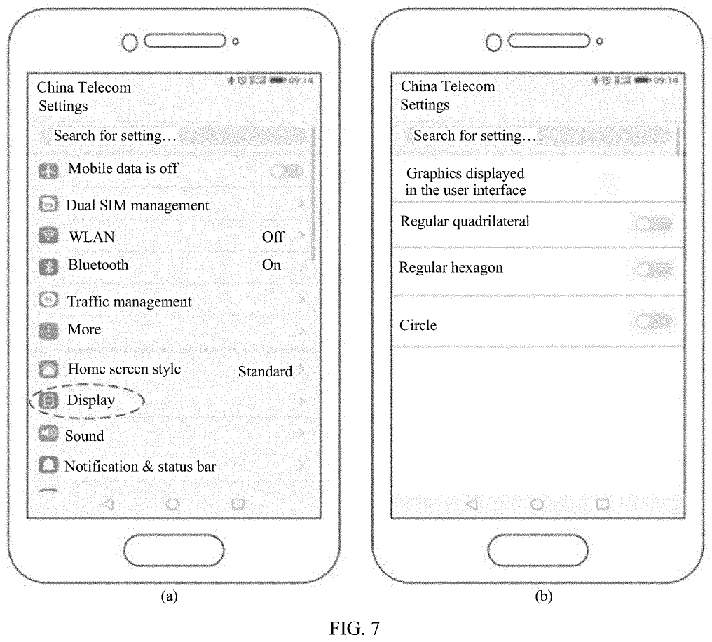

For example, as shown in FIG. 8, assuming that the first graphic is a regular hexagon, based on an actual display requirement, coordinates of a central point P0 of the regular hexagon on the screen of the mobile terminal may be predefined as (P_{X0}, P_{Y0}), a radius of the regular hexagon may be predefined as R, and a quantity N of vertices of the regular hexagon may be predefined as 6.

It should be noted that in this embodiment of the present invention, because the mobile terminal dynamically displays the second UI by using the first graphic (in this case, the radius of the first graphic, or the radius of the first graphic and the central point of the first graphic change each time the mobile terminal displays the second UI), the coordinates of the central point of the predefined first graphic may be considered as coordinates of an initial central point of the first graphic, and the radius of the predefined first graphic may also be considered as an initial radius of the first graphic.

S110b. The mobile terminal obtains coordinates of vertices of the first graphic based on the coordinates of the central point of the first graphic, the radius of the first graphic, and the quantity of vertices of the first graphic.

After the mobile terminal obtains the coordinates of the central point of the predefined first graphic, the radius of the first graphic, and the quantity of vertices of the first graphic, the mobile terminal may obtain the coordinates of the vertices of the first graphic based on the coordinates of the central point of the first graphic, the radius of the first graphic, and the quantity of vertices of the first graphic. In this way, the mobile terminal can obtain the coordinates of the central point of the predefined first graphic and the coordinates of the vertices of the first graphic by performing S110a and S110b.

Optionally, in this embodiment of the present invention, the coordinates of the central point of the first graphic include a horizontal coordinate of the central point of the first graphic and a vertical coordinate of the central point of the first graphic, and the coordinates of the vertices of the first graphic include horizontal coordinates of the vertices of the first graphic and vertical coordinates of the vertices of the first graphic. In this case, S110b may be specifically implemented by performing S110b1 and S110b2.

S110b1. The mobile terminal obtains horizontal coordinates of the vertices of the first graphic based on a horizontal coordinate of the central point of the first graphic, the radius of the first graphic, and the quantity of vertices of the first graphic by using a first formula.

In this embodiment of the present invention, the first formula may be P_{Xi}=P_{X0}+R*cos(i*360/N)). N indicates the quantity of vertices of the first graphic, P_{Xi} indicates a horizontal coordinate of an i^{th} vertex in N vertices of the first graphic, P_{X0} indicates the horizontal coordinate of the central point of the first graphic, R indicates the radius of the first graphic, i indicates the i^{th} vertex in the N vertices of the first graphic, and i∈[1, N].

S110b2. The mobile terminal obtains vertical coordinates of the vertices of the first graphic based on a vertical coordinate of the central point of the first graphic, the radius of the first graphic, and the quantity of vertices of the first graphic by using a second formula.

In this embodiment of the present invention, the second formula may be P_{Yi}=P_{Y0}+R*cos(i*360/N)). P_{Yi} indicates a vertical coordinate of the i^{th} vertex in the N vertices of the first graphic, and P_{Y0} indicates the vertical coordinate of the central point of the first graphic. For meanings indicated by R, i, and N, refer to the meanings indicated by R, i, and N in the foregoing descriptions of Formula 1. Details are not described herein again.

The mobile terminal may obtain the coordinates of the vertices of the predefined first graphic (including the horizontal coordinates of the vertices and the vertical coordinates of the vertices) by performing S110b1 and S110b2.

It may be understood that in this embodiment of the present invention, the first formula and the second formula are respectively described only by using the horizontal coordinate and the vertical coordinate of the i^{th} vertex in the N vertices of the first graphic as examples. Specifically, a horizontal coordinate and a vertical coordinate of each of the N vertices of the first graphic may be respectively calculated by using the first formula and the second formula, and details are not described herein again.

Optionally, in this embodiment of the present invention, the location parameter of the predefined first graphic may further include a width of the first graphic and a height of the first graphic. The location parameter of the second UI may include coordinates of a central point of the second UI and coordinates of vertices of the second UI. In this case, S111 may be specifically implemented by performing S111a and S111b.

S111a. The mobile terminal obtains coordinates of a central point of the second UI based on the coordinates of the central point of the first graphic, a width of the first graphic, and a height of the first graphic.

S111b. The mobile terminal obtains coordinates of vertices of the second UI based on the coordinates of the vertices of the first graphic, the width of the first graphic, and the height of the first graphic.

After the mobile terminal obtains the coordinates of the central point of the first graphic and the coordinates of the vertices of the first graphic, the mobile terminal may obtain the coordinates of the central point of the second UI and the coordinates of the vertices of the second UI based on the coordinates of the central point of the first graphic and the coordinates of the vertices of the first graphic with reference to the width of the first graphic and the height of the first graphic. In this way, the mobile terminal can obtain the coordinates of the central point of the second UI and the coordinates of the vertices of the second UI by performing S111a and S111b.

Optionally, in this embodiment of the present invention, the coordinates of the central point of the predefined first graphic include the horizontal coordinate of the central point of the first graphic and the vertical coordinate of the central point of the first graphic, the coordinates of the vertices of the first graphic include the horizontal coordinates of the vertices of the first graphic and the vertical coordinates of the vertices of the first graphic, the coordinates of the central point of the second UI include a horizontal coordinate of the central point of the second UI and a vertical coordinate of the central point of the second UI, and the coordinates of the vertices of the second UI include horizontal coordinates of the vertices of the second UI and vertical coordinates of the vertices of the second UI. In this case, S111a may be specifically implemented by performing S111a1 and S111a2, and S111b may be specifically implemented by performing S111b1 and S111b2.

S111a1. The mobile terminal obtains a horizontal coordinate of the central point of the second UI based on the horizontal coordinate of the central point of the first graphic and the width of the first graphic by using a third formula.

In this embodiment of the present invention, the third formula may be T_{X0}=P_{X0}/W. T_{X0} is the horizontal coordinate of the central point of the second UI, P_{X0} is the horizontal coordinate of the central point of the first graphic, and W is the width of the first graphic.

S111a2. The mobile terminal obtains a vertical coordinate of the central point of the second UI based on the vertical coordinate of the central point of the first graphic and the height of the first graphic by using a fourth formula.

In this embodiment of the present invention, the fourth formula may be T_{Y0}=P_{Y0}/H. T_{Y0} is the vertical coordinate of the central point of the second UI, P_{Y0} is the vertical coordinate of the central point of the first graphic, and H is the height of the first graphic.

In this embodiment of the present invention, the width of the first graphic and the height of the first graphic may also be predefined, and the width of the first graphic and the height of the first graphic may be considered as a maximum width of the first graphic and a maximum height of the first graphic. The maximum width and the maximum height of the first graphic are a width and a height of the first graphic when the mobile terminal displays the second UI in full screen (a maximum width and a maximum height of content that can be originally displayed on the screen of the mobile terminal), for example, W and H shown in FIG. 8.

For example, as shown in FIG. 8, assuming that the first graphic is a regular hexagon, based on an actual display requirement, a width of the regular hexagon may be predefined as W and a height of the regular hexagon may be predefined as H.

S111b1. The mobile terminal obtains horizontal coordinates of the vertices of the second UI based on the horizontal coordinates of the vertices of the first graphic and the width of the first graphic by using a fifth formula.

In this embodiment of the present invention, the fifth formula may be T_{Xi}=P_{Xi}/W. T_{Xi} is a horizontal coordinate of an i^{th} vertex of the second UI, P_{Xi} is the horizontal coordinate of the i^{th} vertex of the first graphic, and W is the width of the first graphic.

It should be noted that in this embodiment of the present invention, because the mobile terminal displays the second UI by using the first graphic, in other words, the second UI and the first graphic are displayed through complete superimposition, a quantity of vertices of the second UI is the same as the quantity of vertices of the first graphic, and the quantity of vertices of the second UI is also N.

S111b2. The mobile terminal obtains vertical coordinates of the vertices of the second UI based on the vertical coordinates of the vertices of the first graphic and the height of the first graphic by using a sixth formula.

In this embodiment of the present invention, the sixth formula may be T_{Yi}=P_{Yi}/H. T_{Yi} a vertical coordinate of the i^{th} vertex of the second UI, P_{Yi} is the vertical coordinate of the i^{th} vertex of the first graphic, and H is the height of the first graphic.

It may be understood that in this embodiment of the present invention, the fifth formula and the sixth formula are respectively described only by using the horizontal coordinate and the vertical coordinate of the i^{th} vertex in N vertices of the first graphic and the second UI as examples. Specifically, a horizontal coordinate and a vertical coordinate of each of the N vertices of the first graphic and the second UI may be respectively calculated by using the fifth formula and the sixth formula, and details are not described herein again.

It can be learned from the first formula and the second formula that, both the calculated horizontal coordinates and the calculated vertical coordinates of the vertices of the first graphic in this embodiment of the present invention are absolute coordinates, for example, may be absolute coordinates of the vertices of the first graphic on the screen of the mobile terminal. It can be learned from the third formula and the fourth formula that, the calculated horizontal coordinate and the calculated vertical coordinate of the central point of the second UI in this embodiment of the present invention are relative coordinates (or referred to as normalized coordinates), for example, may be relative coordinates of the central point of the second UI relative to the central point of the first graphic. It can be learned from the fifth formula and the sixth formula that, the calculated horizontal coordinates and the calculated vertical coordinates of the vertices of the second UI in this embodiment of the present invention are also relative coordinates (or referred to as normalized coordinates), for example, may be relative coordinates of the vertices of the second UI relative to the vertices of the first graphic. In this way, the mobile terminal displays the first graphic by using absolute coordinates, and displays the second UI by using relative coordinates, so that the mobile terminal can accurately display the second UI on the screen of the mobile terminal by using the first graphic, to improve a display effect of the second UI dynamically displayed by the mobile terminal.

Optionally, in this embodiment of the present invention, because the process in which the mobile terminal displays the second UI by using the first graphic is a dynamic change process, it may be considered that the second UI includes a plurality of frames of images, and therefore the mobile terminal can dynamically display the second UI by continuously displaying all of the plurality of frames of images by using the first graphic. When the mobile terminal displays each of the plurality of frames of images by using the first graphic, the mobile terminal may obtain each location parameter of the first graphic and each location parameter of the second UI by using Formula 1, Formula 2, Formula 3, Formula 4, Formula 5, and Formula 6, so that the mobile terminal can dynamically display the second UI based on the location parameters by using the first graphic. In this way, a display effect of the second UI displayed by the mobile terminal is further diversified.

In this embodiment of the present invention, when the mobile terminal displays each of the plurality of frames of images of the second UI by using the first graphic, the radius of the first graphic may change. Therefore, before the mobile terminal displays each frame of image by using the first graphic, the mobile terminal needs to first obtain a radius of the first graphic when the mobile terminal displays the frame of image or a radius of the first graphic and coordinates of a central point of the first graphic when the mobile terminal displays the frame of image by using the first graphic. The following provides example descriptions in two optional implementations (a first optional implementation and a second optional implementation described below).

In the first optional implementation, if the location of the central point of the first graphic in the first UI is fixed (to be specific, the location of the central point of the first graphic in the first UI is fixed when the mobile terminal displays each of the plurality of frames of images of the second UI by using the first graphic), the mobile terminal may obtain, by performing steps S0 and S1, a radius of the first graphic when the mobile terminal displays each of the plurality of frames of images of the second UI by using the first graphic.

S0. The mobile terminal obtains a parameter of a current frame of image, where the parameter of the current frame of image includes total duration of a plurality of frames of images, a first radius of the first graphic, and a second radius of the first graphic.

The current frame of image is an image that is of the second UI and that currently needs to be displayed by the mobile terminal. The first radius is a radius of the first graphic when the mobile terminal displays a first frame of image in the plurality of frames of images, and the second radius is a radius of the first graphic when the mobile terminal displays a last frame of image in the plurality of frames of images.

S1. The mobile terminal obtains a radius of the first graphic based on the total duration of the plurality of frames of images, the first radius, and the second radius when the mobile terminal displays the current frame of image.

It may be understood that in this embodiment of the present invention, the initial radius of the first graphic may be predefined as the first radius, and an end radius of the first graphic may be predefined as the second radius. The initial radius of the first graphic is a radius of the first graphic when the mobile terminal displays the first frame of image in the plurality of frames of images of the second UI by using the first graphic, and the end radius of the first graphic is a radius of the first graphic when the mobile terminal displays the last frame of image in the plurality of frames of images by using the first graphic. A radius of the first graphic when the mobile terminal displays another frame of image in the plurality of frames of images (a frame of image other than the first frame of image and the last frame of image in the plurality of frames of images) by using the first graphic may be calculated based on the total duration of the plurality of frames of images, the first radius, and the second radius.

For example, assuming that the total duration of the plurality of frames of images of the second UI is T, the predefined first radius is R1, and the predefined second radius is R2, if the current frame of image to be displayed by the mobile terminal is an m^{th} frame of image in the plurality of frames of images, a radius of the first graphic when the mobile terminal displays the current frame of image by using the first graphic is Rm=R1+(R2−R1)*ΔT/t. ΔT is a time difference between starting to display the first frame of image of the second UI by the mobile terminal and completing displaying an (m−1)^{th} frame of image of the second UI by the mobile terminal. For example, assuming that the second UI includes five frames of images, total duration of the five frames of images is 500 ms, and the current frame of image to be displayed by the mobile terminal is a third (m=3) frame of image in the five frames of images, if a time point at which the mobile terminal starts to display the first frame of image of the second UI is 0 ms, and a time point at which the mobile terminal completes displaying a second (m−1=3−1=2) frame of image of the second UI is 200 ms, ΔT=200 ms−0 ms=200 ms.

It may be understood that for each of the plurality of frames of images of the second UI, ΔT may be understood as an advance time difference of the frame of image when the mobile terminal displays the frame of image.

In this embodiment of the present invention, when the mobile terminal displays each of the plurality of frames of images of the second UI, an advance time difference of the frame of image may be recorded by using an interface (for example, an interface used for time recording) in the mobile terminal, to obtain ΔT.

In this embodiment of the present invention, if the location of the central point of the first graphic in the first UI is fixed, the mobile terminal may obtain, by performing S0 and S1, the radius of the first graphic when the mobile terminal displays each of the plurality of frames of images of the second UI by using the first graphic, so that the mobile terminal can display all the frames of images by using first graphics with different radiuses. In this way, the mobile terminal can display the second UI by using a dynamically changing first graphic.

In the second optional implementation, if the location of the central point of the first graphic in the first UI is variable (to be specific, the location of the central point of the first graphic in the first UI is variable when the mobile terminal displays each of the plurality of frames of images of the second UI by using the first graphic), the mobile terminal may obtain, by performing steps S2 to S4, a radius of the first graphic and coordinates of a central point of the first graphic when the mobile terminal displays each of the plurality of frames of images of the second UI by using the first graphic.

S2. The mobile terminal obtains a parameter of a current frame of image, where the parameter of the current frame of image includes total duration of a plurality of frames of images, a first radius of the first graphic, a second radius of the first graphic, coordinates of a first central point of the first graphic, and coordinates of a second central point of the first graphic.

The current frame of image is an image that is of the second UI and that currently needs to be displayed by the mobile terminal. The first radius is a radius of the first graphic when the mobile terminal displays a first frame of image in the plurality of frames of images, the second radius is a radius of the first graphic when the mobile terminal displays a last frame of image in the plurality of frames of images, the first central point is a central point of the first graphic when the mobile terminal displays the first frame of image, and the second central point is a central point of the first graphic when the mobile terminal displays the last frame of image.

S3. The mobile terminal obtains a radius of the first graphic based on the total duration of the plurality of frames of images, the first radius, and the second radius when the mobile terminal displays the current frame of image.

For specific descriptions of S3, refer to related descriptions of S1 described above, and details are not described herein again.

S4. The mobile terminal obtains coordinates of a central point of the first graphic based on the total duration of the plurality of frames of images, the coordinates of the first central point, and the coordinates of the second central point when the mobile terminal displays the current frame of image.

It may be understood that in this embodiment of the present invention, the coordinates of the initial central point of the first graphic may be predefined as the coordinates of the first central point, and coordinates of an end central point of the first graphic may be predefined as the coordinates of the second central point. The coordinates of the initial central point of the first graphic are coordinates of a central point of the first graphic when the mobile terminal displays the first frame of image in the plurality of frames of images of the second UI by using the first graphic, and the coordinates of the end central point of the first graphic are coordinates of a central point of the first graphic when the mobile terminal displays the last frame of image in the plurality of frames of images by using the first graphic. Coordinates of a central point of the first graphic when the mobile terminal displays another frame of image in the plurality of frames of images (a frame of image other than the first frame of image and the last frame of image in the plurality of frames of images) by using the first graphic may be calculated based on the total duration of the plurality of frames of images, the coordinates of the first central point, and the coordinates of the second central point.

For example, assuming that the total duration of the plurality of frames of images of the second UI is T, the predefined coordinates of the first central point are (P_{X01}, P_{Y01}), and the predefined coordinates of the second central point are (P_{X02}, P_{Y02}), if the current frame of image to be displayed by the mobile terminal is an m^{th} frame of image in the plurality of frames of images, coordinates of a central point of the first graphic when the mobile terminal displays the current frame of image by using the first graphic are P_{X01}=P_{X01}+(P_{X02}−P_{X01})*ΔT/T and P_{Y0x}=P_{Y01}+(P_{Y02}−P_{Y01})*Δt/T. P_{X01} is a horizontal coordinate of the first central point, P_{Y01} is a vertical coordinate of the first central point, P_{X01} is a horizontal coordinate of the second central point, P_{Y02} is a vertical coordinate of the second central point, P_{X0x} is a horizontal coordinate of the central point of the first graphic when the mobile terminal displays the current frame of image by using the first graphic, P_{Y0x} is a vertical coordinate of the central point of the first graphic when the mobile terminal displays the current frame of image by using the first graphic, and AT is a time difference between starting to display the first frame of image of the second UI by the mobile terminal and completing displaying an (m−1)^{th} frame of image of the second UI by the mobile terminal. For other specific descriptions and examples of ΔT, refer to related descriptions and examples of ΔT in the first optional implementation, and details are not described herein again.

In this embodiment of the present invention, if the location of the central point of the first graphic in the first UI is variable, the mobile terminal may obtain, by performing S2 to S4, the radius of the first graphic and the coordinates of the central point of the first graphic when the mobile terminal displays each of the plurality of frames of images of the second UI by using the first graphic, so that the mobile terminal can display all the frames of images by using first graphics with different radiuses and different central points. In this way, the mobile terminal can display the second UI by using a dynamically changing first graphic.

It may be understood that in this embodiment of the present invention, the first formula, the second formula, the third formula, the fourth formula, the fifth formula, and the sixth formula each are described by using an example in which the mobile terminal displays one frame of image. Specifically, when the mobile terminal displays each of the plurality of frames of images of the second UI, the mobile terminal may calculate a horizontal coordinate and a vertical coordinate of each vertex of the first graphic, a horizontal coordinate and a vertical coordinate of a central point of the second UI, and a horizontal coordinate and a vertical coordinate of each vertex of the second UI by using the first formula, the second formula, the third formula, the fourth formula, the fifth formula, and the sixth formula. In this way, the mobile terminal can display the second UI by using a dynamically changing first graphic, thereby diversifying an effect of the second UI displayed by the mobile terminal.

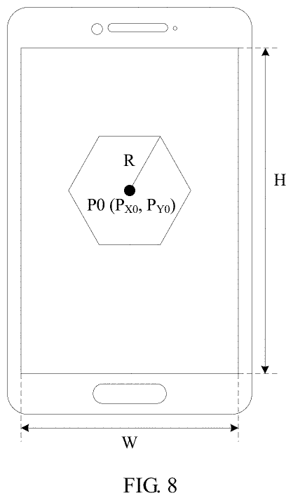

The following briefly describes a specific implementation process of the user interface display method provided in the embodiments of the present invention from a perspective of an Android operating system. With reference to FIG. 1, as shown in FIG. 9, an application program layer and an application program framework layer in the Android operating system may be understood as a Java virtual machine (java virtual machine, JVM) in an Android operating system software implementation, and a system runtime library layer and a kernel layer in the Android operating system may be understood as a native framework (that is, Native shown in FIG. 9) in the Android operating system software implementation. To implement the user interface display method provided in the embodiments of the present invention based on the JVM and Native in the Android operating system, when a mobile terminal displays a first UI, if a user enters a first instruction, for example, the user taps an icon of “Settings” (for example, a “Settings” application in the application program layer shown in FIG. 9) on a home screen of the mobile terminal, as shown in FIG. 9, a location parameter of a first graphic when the mobile terminal displays an interface of the “Settings” application by using the first graphic may be transmitted by the application program layer to an activity manager in the application program framework layer based on the JVM, the activity manager transmits the location parameter of the first graphic to a window manager in the application program framework layer based on the JVM, and then the window manager transmits the location parameter of the first graphic to an interface manager in a library in the system runtime library layer based on the JVM. In this case, the interface manager draws, based on Native and the location parameter of the first graphic, the first graphic in the first UI displayed by the mobile terminal, so that the mobile terminal can display, by using the first graphic, a second UI in the first UI displayed by the mobile terminal.

It may be understood that in this embodiment of the present invention, if the location parameter of the first graphic is set to be fixed, a shape of the first graphic may be fixed when the mobile terminal displays the second UI by using the first graphic, in other words, the mobile terminal displays the second UI by using the first graphic of the fixed shape. If the location parameter of the first graphic is set to be dynamically variable, when the mobile terminal displays the second UI by using the first graphic, a shape of the first graphic is dynamically variable, in other words, the mobile terminal displays the second UI by using the dynamically variable first graphic.

It may be understood that the Android operating system shown in FIG. 9 may include same layers and same components as the Android operating system shown in FIG. 1. For ease of description, some components in the Android operating system shown in FIG. 1 are used as an example for description in FIG. 9. For specific layers and components in the layers in the Android operating system shown in FIG. 9, refer to related descriptions of the layers and the components in the layers in the Android operating system shown in FIG. 1 in the foregoing embodiment, and details are not described herein again.

The solutions provided in the embodiments of the present invention are described mainly from a perspective of a mobile terminal in the foregoing embodiment. It may be understood that to implement the foregoing functions, the mobile terminal provided in the embodiments of the present invention includes corresponding hardware structures and/or software modules for performing the functions. A person skilled in the art may be readily aware that, in combination with the example modules and algorithm steps described in the embodiments disclosed in this specification, the embodiments of the present invention can be implemented in a form of hardware or a combination of hardware and computer software. Whether a function is performed by hardware or computer software by driving hardware depends on particular applications and design constraint conditions of the technical solutions. A person skilled in the art may use different methods to implement the described functions for each specific application, but it should not be considered that the implementation goes beyond the scope of this application.

In the embodiments of the present invention, function module division may be performed on the mobile terminal based on the foregoing method examples. For example, each function module may be obtained through division based on a corresponding function, or two or more functions may be integrated into one module. The integrated module may be implemented in a form of hardware, or may be implemented in a form of a software functional module. It should be noted that the module division in the embodiments of the present invention is an example, and is merely logical function division, and there may be another division manner in actual implementation.

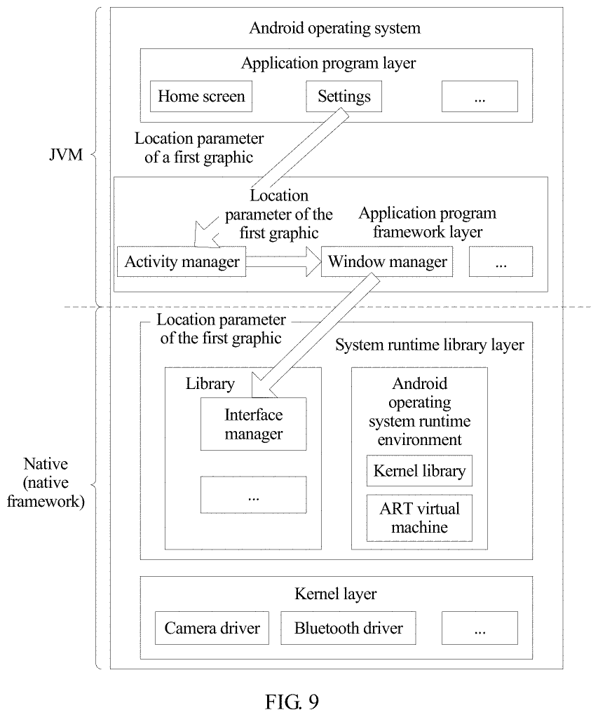

When each function module is obtained through division based on a corresponding function, FIG. 10 is a possible schematic structural diagram of a mobile terminal according to an embodiment of the present invention. As shown in FIG. 10, the mobile terminal may include an obtaining module 20 and a display module 21. The obtaining module 20 may be configured to support the mobile terminal in performing S11, S13, and S110 to S111 (including S110a and S110b, S110b1 and S110b2, S111a and S111b, S111b1 and S111b2, and S0 and S1, or S2 to S4) performed by the mobile terminal in the foregoing method embodiment. The display module 21 may be configured to support the mobile terminal in performing S10 and S12 performed by the mobile terminal in the foregoing method embodiment. All related content of each step in the foregoing method embodiment may be cited in function descriptions of a corresponding function module, and details are not described herein.

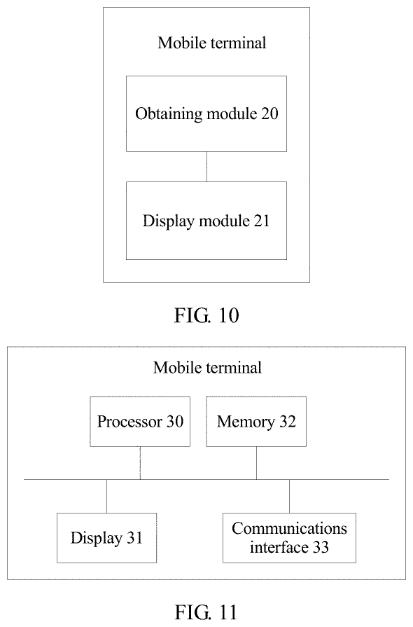

As shown in FIG. 11, FIG. 11 is another schematic structural diagram of a mobile terminal according to an embodiment of the present invention. In FIG. 11, the mobile terminal may include a processor 30, a display 31, and a memory 32. The processor 30 may be configured to control and manage an action of the mobile terminal. For example, the processor 30 may be configured to support the mobile terminal in performing S11, S13, and S110 to S111 (including S110a and S110b, S110b1 and S110b2, S111a and S111b, S111b1 and S111b2, S0 and S1, or S2 to S4) performed by the mobile terminal in the foregoing method embodiment, and/or used for another process of the technology described in this specification. The display 31 may be configured to support the mobile terminal in performing S10 and S12 performed by the mobile terminal in the foregoing method embodiment, and/or used for another display process of the technology described in this specification. The memory 32 may be configured to store program code and data of the mobile terminal. For example, the memory 32 may be configured to store a first instruction, a second instruction, each parameter of a first graphic, each parameter of a second UI, and the like that are obtained by the processor 30. The memory 32 may be further configured to support the mobile terminal in performing the steps performed by the mobile terminal in the foregoing method embodiment, and/or used for another process of the technology described in this specification. Optionally, as shown in FIG. 11, the mobile terminal may further include a communications interface 33. The communications interface 33 is configured to support communication between the mobile terminal and another device. For example, the communications interface 33 may be configured to support interaction between the mobile terminal and another mobile terminal.

The processor 30 may be a central processing unit (central processing unit, CPU), a general-purpose processor, a digital signal processor (digital signal processor, DSP), an application-specific integrated circuit (application-specific integrated circuit, ASIC), a field-programmable gate array (field-programmable gate array, FPGA) or another programmable logic device, a transistor logic device, a hardware component, or any combination thereof The processor 30 may implement or execute various example logical blocks, modules, and circuits described with reference to content disclosed in the embodiments of the present invention. Alternatively, the processor may be a combination that implements a computing function, for example, a combination that includes one or more microprocessors, or a combination of a DSP and a microprocessor. For example, the processor 30 may be the processor 10 shown in FIG. 2. The display 31 may be the display module 15 shown in FIG. 2. The memory 32 may be the memory 13 shown in FIG. 2. The communications interface 33 may be the RF circuit 11, the input module 14, and the like shown in FIG. 2.

The processor 30, the display 31, the memory 32, and the communications interface 33 may be connected by using a bus. The bus may be a Peripheral Component Interconnect (peripheral component interconnect, PCI) bus, an extended industry standard architecture (extended Industry standard architecture, EISA) bus, or the like. The bus may be classified into an address bus, a data bus, a control bus, and the like.

Specifically, for a structure of the mobile terminal provided in this embodiment of the present invention, refer to related descriptions of the mobile phone in the embodiment shown in FIG. 2. Details are not described herein again.

All or some of the foregoing embodiments may be implemented by software, hardware, firmware, or any combination thereof. When a software program is used to implement the embodiments, the embodiments may be implemented all or partially in a form of a computer program product. The computer program product includes one or more computer instructions. When the computer instructions are loaded and executed on a computer, the procedures or functions according to the embodiments of the present invention are all or partially generated. The computer may be a general-purpose computer, a dedicated computer, a computer network, or another programmable apparatus. The computer instruction may be stored in a computer-readable storage medium or may be transmitted from a computer-readable storage medium to another. For example, the computer instruction may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drives, SSD)), or the like.

An embodiment of the present invention provides a user interface on a mobile terminal. The mobile terminal includes a display, a touch-sensitive surface, a memory, and one or more processors that execute one or more programs stored in the memory. The user interface includes a first UI, a first graphic, and a second UI. The mobile terminal obtains a first instruction entered by a user in the first UI, and displays, in response to the first instruction, the second UI in the first UI by using the first graphic. The first instruction is used to trigger the mobile terminal to perform a first operation. The first graphic is predefined, and the second UI is a UI to be displayed after the mobile terminal performs the first operation.

Optionally, in this embodiment of the present invention, the second UI is dynamically displayed in the first UI by using the first graphic.

Optionally, in this embodiment of the present invention, when the first instruction is an instruction for triggering the mobile terminal to open an application, the second UI is an interface of the application. In a process of displaying the second UI, the first graphic and the second UI gradually expand by using a central point of the first graphic as a center, until the second UI covers the first UI displayed by the mobile terminal. When the first instruction is an instruction for triggering the mobile terminal to close an application, the second UI is an interface of the application. In a process of displaying the second UI by using the first graphic, the first graphic and the second UI gradually shrink towards a central point of the first graphic by using the central point of the first graphic as a center, until the first graphic and the second UI disappear. When the first instruction is an instruction for triggering the mobile terminal to open a message prompt box, the second UI is an interface of the message prompt box. In a process of displaying the second UI by using the first graphic, the first graphic and the second UI gradually expand by using a central point of the first graphic as a center, until a shape of the first graphic becomes a predefined designated shape. When the first instruction is an instruction for triggering the mobile terminal to close a message prompt box, the second UI is an interface of the message prompt box.

In a process of displaying the second UI by using the first graphic, the first graphic and the second UI gradually shrink towards a central point of the first graphic by using the central point of the first graphic as a center, until the first graphic and the second UI disappear.

For specific descriptions of displaying different second UIs by the mobile terminal when the user enters different instructions and dynamically displaying the second UI with different effects by the mobile terminal, refer to related descriptions in Case 1, Case 2, Case 3, and Case 4 in the foregoing method embodiment, and details are not described herein again.

Optionally, in this embodiment of the present invention, in the process of displaying the second UI by using the first graphic, a location of the central point of the first graphic in the first UI is fixed or variable.

Optionally, in this embodiment of the present invention, in the process of displaying the second UI by using the first graphic, transparency of the first graphic gradually changes from first transparency to second transparency.

Optionally, in this embodiment of the present invention, in the process of displaying the second UI by using the first graphic, a speed at which the second UI is displayed by using the first graphic is adjustable.

Optionally, in this embodiment of the present invention, the first graphic may be a regular polygon with N sides, N≥3, and N is an integer.

For specific descriptions of the case in which the location of the central point of the first graphic in the first UI is fixed or variable, the case in which the transparency of the first graphic gradually changes from the first transparency to the second transparency, the case in which the speed at which the second UI is displayed by using the first graphic is adjustable, and the first graphic in the process of displaying the second UI by using the first graphic, refer to related descriptions in the foregoing method embodiment. Details are not described herein again.

In this embodiment of the present invention, the display in the mobile terminal may be, for example, the display module 15 (specifically, the display panel in the display module 15) shown in FIG. 2. The touch-sensitive surface in the mobile terminal may be, for example, the touchscreen 141 shown in FIG. 2. The memory in the mobile terminal may be, for example, the memory 13 shown in FIG. 2. The processor in the mobile terminal may be, for example, the processor 10 shown in FIG. 2. It may be understood that the mobile terminal may further include other components such as various sensors, Wi-Fi modules, and Bluetooth modules.

For other specific descriptions of the user interface provided in this embodiment of the present invention, refer to related descriptions of FIG. 4, FIG. 5A and FIG. 5B, and FIG. 6A and FIG. 6B in the foregoing method embodiment, and details are not described herein again.

The foregoing descriptions about implementations allow a person skilled in the art to clearly understand that, for the purpose of convenient and brief description, division of the foregoing function modules is used as an example for illustration. In actual application, the foregoing functions can be allocated to different function modules and implemented as required, in other words, an inner structure of an apparatus is divided into different function modules to implement all or some of the functions described above. For a detailed working process of the foregoing system, apparatus, and unit, refer to a corresponding process in the foregoing method embodiment, and details are not described herein again.

In the embodiments provided in this application, it should be understood that the disclosed system, apparatus, and method may be implemented in other manners. For example, the described apparatus embodiment is only an example. For example, the module or unit division is only logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected as actually required to achieve the objectives of the solutions of the embodiments.

In addition, functional units in the embodiments of this application may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the prior art, or all or some of the technical solutions may be implemented in the form of a software product. The computer software product is stored in a storage medium and includes several instructions for instructing a computer device (which may be a personal computer, a server, or a network device) or a processor to perform all or some of the steps of the methods described in the embodiments of this application. The foregoing storage medium includes: any medium that can store program code, such as a flash memory, a removable hard disk, a read-only memory, a random access memory, a magnetic disk, or an optical disc.

The foregoing descriptions are merely specific implementations of this application, but are not intended to limit the protection scope of this application. Any variation or replacement falling within the technical scope disclosed in this application shall fall within the protection scope of this application. Therefore, the protection scope of this application shall be subject to the protection scope of the claims.

1-48. (canceled)

49. A user interface (UI) display method, comprising:
displaying, by a mobile terminal, a first UI;
obtaining, by the mobile terminal, a first instruction entered by a user in the first UI, wherein the first instruction is used to trigger the mobile terminal to perform a first operation; and
displaying, by the mobile terminal in response to the first instruction, a second UI in the first UI by using a first graphic, wherein the first graphic is predefined, and the second UI is a UI to be displayed after the mobile terminal performs the first operation.

50. The display method according to claim 49, wherein the displaying, by the mobile terminal, a second UI in the first UI by using a first graphic comprises:
dynamically displaying, by the mobile terminal, the second UI in the first UI by using the first graphic.

51. The display method according to claim 49, further comprising:
obtaining, by the mobile terminal, a second instruction entered by the user, wherein the second instruction is used to trigger the mobile terminal to select the first graphic.

52. The display method according to claim 49, wherein
when the mobile terminal displays the second UI by using the first graphic, the first graphic and the second UI gradually expand by using a central point of the first graphic as a center, until the second UI covers the first UI.

53. The display method according to claim 52, wherein
the first instruction is an instruction for triggering the mobile terminal to open an application, and the second UI is an interface of the application.

54. The display method according to claim 49, wherein
when the mobile terminal displays the second UI by using the first graphic, the first graphic and the second UI gradually expand by using a central point of the first graphic as a center, until a shape of the first graphic becomes a predefined designated shape.

55. The display method according to claim 54, wherein
the first instruction is an instruction for triggering the mobile terminal to open a message prompt box, and the second UI is an interface of the message prompt box.

56. The display method according to 49, wherein
when the mobile terminal displays the second UI by using the first graphic, the first graphic and the second UI gradually shrink towards a central point of the first graphic by using the central point of the first graphic as a center, until the first graphic and the second UI disappear.

57. The display method according to claim 56, wherein
the first instruction is an instruction for triggering the mobile terminal to close an application, and the second UI is an interface of the application; or
the first instruction is an instruction for triggering the mobile terminal to close a message prompt box, and the second UI is an interface of the message prompt box.

58. The display method according to claim 52, wherein
when the mobile terminal displays the second UI by using the first graphic, a location of the central point of the first graphic in the first UI is fixed or variable.

59. The display method according to claim 49, wherein
when the mobile terminal displays the second UI by using the first graphic, transparency of the first graphic gradually changes from first transparency to second transparency.

60. The display method according to claim 49, wherein
when the mobile terminal displays the second UI by using the first graphic, a speed at which the mobile terminal displays the second UI by using the first graphic is adjustable.

61. A mobile terminal, comprising a processor, a display, and a memory, wherein
the display is configured to display a first UI;
the processor is configured to obtain a first instruction entered by a user in the first UI displayed by the display, wherein the first instruction is used to trigger the mobile terminal to perform a first operation;
the display is further configured to display, in response to the first instruction obtained by the processor, a second UI in the first UI by using a first graphic, wherein the first graphic is predefined, and the second UI is a UI to be displayed after the mobile terminal performs the first operation; and
the memory is configured to store the first instruction.

62. The mobile terminal according to claim 61, wherein
the display is specifically configured to dynamically display the second UI in the first UI by using the first graphic.

63. The mobile terminal according to claim 61, wherein
the processor is further configured to obtain a second instruction entered by the user, wherein the second instruction is used to trigger the mobile terminal to select the first graphic; and
the memory is further configured to store the second instruction.

64. The mobile terminal according to claim 61, wherein
when the display displays the second UI by using the first graphic, the first graphic and the second UI gradually expand by using a central point of the first graphic as a center, until the second UI covers the first UI.

65. The mobile terminal according to claim 64, wherein
the first instruction is an instruction for triggering the mobile terminal to open an application, and the second UI is an interface of the application.

66. The mobile terminal according to claim 61, wherein
when the display displays the second UI by using the first graphic, the first graphic and the second UI gradually expand by using a central point of the first graphic as a center, until a shape of the first graphic becomes a predefined designated shape.

67. The mobile terminal according to claim 66, wherein
the first instruction is an instruction for triggering the mobile terminal to open a message prompt box, and the second UI is an interface of the message prompt box.

68. A user interface on a mobile terminal, wherein the mobile terminal comprises a display, a touch-sensitive surface, a memory, and one or more processors that execute one or more programs stored in the memory, and the user interface comprises a first UI, a first graphic, and a second UI; and
the mobile terminal obtains a first instruction entered by a user in the first UI, and displays, in response to the first instruction, the second UI in the first UI by using the first graphic, wherein the first instruction is used to trigger the mobile terminal to perform a first operation, the first graphic is predefined, and the second UI is a UI to be displayed after the mobile terminal performs the first operation.
